(19) United States
(12) Patent Application Publication
(10) Pub. No.: US 2009/0135700 A1
(43) Pub. Date: May 28, 2009

(54) STORAGE CONTROLLER AND STORAGE CONTROLLER CONTROL METHOD

(76) Inventor: Akira FUJIBAYASHI, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/031,953

(22) Filed: Feb. 15, 2008

(30) Foreign Application Priority Data
Nov. 28, 2007 (JP) 2007-308067

(51) Int. Cl. G11B 3/64

(52) U.S. Cl. 369/85

(57) ABSTRACT

A storage controller of the present invention makes use of the differences in power rates by time zone and geographic region to control the data storage destination between storage devices of different power consumption. The storage controllers of respective sites each comprise a hard disk and flash memory device, which consume different amounts of power. A schedule manager manages a schedule for controlling the data storage destination utilized by the host. At night, when the power rate is low, data is copied from a hard disk to a flash memory device. In the daytime, when the power rate is high, an access from the host is processed using the data inside the flash memory device. Copying data between remote sites makes it possible to reduce the power costs of the storage system as a whole.

### CROSS-REFERENCE TO RELATED APPLICATION

This application relates to and claims the benefit of priority from Japanese Patent Application No. 2007-308067, filed on Nov. 28, 2007, the entire disclosure of which is incorporated herein by reference.

### BACKGROUND OF THE INVENTION

1. Field of the Invention

The present invention relates to a storage controller and a storage controller control method.

2. Description of the Related Art

For example, private companies and other such organizations use storage systems to manage large amounts of data. For example, organizations such as financial institutions and hospitals must store financial data and diagnostic data for long periods of time, and as a result need highly reliable, large capacity storage systems. Accordingly, storage systems, which have a large number of sites and hold copies of data at a plurality of sites, are becoming a reality.

Storage controllers are provided at the respective sites of the storage system. A storage controller, for example, comprises a large number of hard disk drives, and can provide storage areas to a host on the basis of RAID (Redundant Array of Independent Disks).

The data being managed by companies for long periods of time is growing day by day. Therefore, the number of hard disk drives mounted in a storage controller is also continuing to grow. A hard disk drive, as is well known, reads and writes data by a magnetic head performing seek operations while a magnetic disk is rotated at high speed by a spindle motor. For this reason, the hard disk drive consumes much more power than a semiconductor memory or other such storage device.

The larger the storage capacity of the storage controller, the greater the number of hard disk drives mounted therein. Therefore, the power consumed by the storage controller becomes greater. As power consumption increases, the total cost of operation (TCO) of the storage system also increases.

Therefore, technology called MAID (Massive Array of Idle Disks) is used to reduce power consumption by putting hard disks that are not being used in the standby state. Further, technology designed to improve response performance by transitioning a standby hard disk to the spin-up state as fast as possible (Japanese Patent Laid-open No. 2007-79749), and technology for managing the amount of power consumed by a hard disk in accordance with the operational performance of a logical volume (Japanese Patent Laid-open No. 2007-79754) have been proposed.

Furthermore, this applicant has filed an application for an invention that migrates data between a low-power-consumption storage device and a high-power-consumption storage device (Japanese Patent Application No. 2007-121379). However, this application has yet to be laid open to the public, and does not correspond to the prior art.

In the above-mentioned prior art, the amount of power consumed by the hard disk drive can be reduced. However, further reductions in power costs are required today. In recent years, the flash memory device has been gaining attention as a new storage device. Compared to the hard disk drive, the flash memory device generally consumes less power, and features a faster data read-out speed.

However, due to the physical structure of the cells, the flash memory device can only perform a limited number of write operations. Also, since the charge stored in a cell depletes over time, a refresh operation must be executed at regular intervals in order to store data for a long period of time.

Because a storage controller is required to store large amounts of data stably for a long period of time, it is difficult to use flash memory devices as-is. Even if flash memory devices and hard disk drives are both mounted in the storage controller, if host computer access is hard disk drive intensive, it will not be possible to reduce the amount of power consumed by the storage controller as a whole.

Now then, power rates will generally differ by geographical region and time of day. For example, the power rate in one region may be either higher or lower than the power rate in another region. Furthermore, generally speaking, the power rate is set higher during the daytime hours when power demand is great, and the power rate is set lower during the nighttime when the demand for power is low. When the respective sites of a storage system are widely separated, one site can be in a high power rate time zone, while another site is in a low power rate time zone. Therefore, in a storage system comprising sites that are distributed across a wide area, the power costs of the storage system as a whole cannot be reduced without taking geographical regions and times of day into account during operation.

### SUMMARY OF THE INVENTION

Accordingly, an object of the present invention is to provide a storage system and data migration method that make it possible to reduce the cost of power by taking power costs into account when shifting a data storage destination between sites, or shifting a data storage destination between storage devices, which are provided inside the same site, and for which power consumption differs respectively. Further objects of the present invention should become clear from the descriptions of the embodiments provided hereinbelow.

To solve the above-mentioned problems, a storage system conforming to a first aspect of the present invention connects a plurality of physically separated sites via a communication network, and comprises: a first site, which is included in the plurality of sites and is provided in a first region, and has a first host computer and a first storage controller, which is connected to this first host computer; and a second site, which is included in the plurality of sites and is provided in a second region, and has a second host computer and a second storage controller, which is connected to this second host computer, the first storage controller and second storage controller respectively comprising a first storage device for which power consumption is relatively low; a second storage device for which power consumption is relatively high; and a controller for respectively controlling a first data migration for migrating prescribed data between the first storage device and the second storage device, and a second data migration for migrating the prescribed data between the respective sites, and the storage system is provided with a schedule manager for managing schedule information which is used for migrating the prescribed data in accordance with power costs, and in which a first migration plan for migrating the prescribed data between the first storage device and the second storage device inside the same storage controller and a second migration plan for migrating the prescribed data between the first storage controller and the second storage controller are respectively configured, and the controllers of the first storage controller and the second storage controller migrate the prescribed data in accordance with the schedule information, which is managed by the respective schedule managers.

In a second aspect according to the first aspect, the cost of power in the first region and the cost of power in the second region differ.

In a third aspect according to either of the first aspect or second aspect, the schedule information is configured in either the first site or the second site, whichever site has a higher cost of power, so as to minimize the rate of operation of the second storage device in the time zone, when the cost of power is relatively high.

In a fourth aspect according to either the first aspect or the second aspect, the schedule information is configured in either the first site or the second site, whichever site has a lower cost of power, so as to make the rate of operation of the second storage device in the time zone, when the cost of power is relatively low, higher than the rate of operation in the time zone, when the cost of power is relatively high.

In a fifth aspect according to any of the first through the fourth aspects, the first migration plan of the schedule information is configured so as to dispose the prescribed data in the first storage device in the time zone, when the cost of power is relatively high, and to dispose the prescribed data in the second storage device in the time zone, when the cost of power is relatively low.

In a sixth aspect according to any of the first through the fifth aspects, the second migration plan of the schedule information is configured such that the prescribed data is disposed in either the first storage controller or the second storage controller, whichever has a lower cost of power.

In a seventh aspect according to any of the first through the sixth aspects, the first controller processes an access request from the first host using the first storage device inside the first storage controller, and the second controller processes an access request from the second host using the second storage device inside the second storage controller.

In an eighth aspect according to any of the first through the seventh aspects, the schedule manager is provided in both the first site and the second site, and the schedule manager inside the first site shares the schedule information with the schedule manager inside the second site.

In a ninth aspect according to any of the first through the eighth aspects, respective logical volumes are provided in the first storage device and the second storage device, and the migration of the prescribed data between the first storage device and the second storage device is carried out using the respective logical volumes.

In a tenth aspect according to any of the first through the ninth aspects, a third migration plan for shifting job processing between the first host computer and the second host computer is also configured in the schedule information in accordance with the cost of power.

In an eleventh aspect according to the tenth aspect, the third migration plan is configured so as to be implemented in conjunction with the second migration plan.

In a twelfth aspect according to any of the first through the tenth aspects, the storage controller inside the site, which constitutes the migration source of the respective sites, upon implementing the second migration plan, selects from among the other respective sites a migration-destination site, which coincides with a pre-configured prescribed condition, and executes the second migration plan to the storage controller inside this migration-destination site.

In a thirteenth aspect according to the twelfth aspect, the prescribed condition comprises at least one condition from among a communication channel for copying data between the migration-source site and the migration-destination site having been configured; the response time, when the prescribed data is migrated to the storage controller inside the migration-destination site, exceeding a pre-configured minimum response time; and the storage controller inside the migration-destination site comprising the storage capacity for storing the prescribed data.

In a fourteenth aspect according to any of the first through the thirteenth aspects, further comprising an access status manager for detecting and managing the state in which either the first host computer or the second host computer accesses the prescribed data, and the schedule manager uses the access status manager to create the schedule information.

In a fifteenth aspect according to any of the first through the fourteenth aspects, the respective controllers estimate the life of the first storage device based on the utilization status of the first storage device, and when the estimated life reaches a prescribed threshold, change the storage destination of the prescribed data to either the second storage device or another first storage device.

In the sixteenth aspect according to any of the first through the fourteenth aspects, the respective controllers estimate the life of the first storage device based on the utilization status of the first storage device, and when the estimated life reaches a prescribed threshold and the ratio of read requests for the first storage device is less than a pre-configured determination threshold, change the storage destination of the prescribed data to either the second storage device or another first storage device.

In a seventeenth aspect according to any of the first through the sixteenth aspects, the first storage device is a flash memory device, and the second storage device is a hard disk device.

A data migration method of the present invention in accordance with an eighteenth aspect is a method for migrating data between a plurality of physically separated sites for the storage system which comprises: a first site, which is included in the plurality of sites and is provided in a first region, and has a first host computer and a first storage controller, which is connected to this first host computer; and a second site, which is included in the plurality of sites and is provided in a second region, and has a second host computer and a second storage controller, which is connected to this second host computer, the first storage controller and second storage controller respectively comprising a first storage device for which power consumption is relatively low; a second storage device for which power consumption is relatively high; and a controller for respectively controlling a first data migration for migrating prescribed data between the first storage device and the second storage device, and a second data migration for migrating the prescribed data between the respective sites, and the data migration method executes a step for migrating the prescribed data between the first storage device and the second storage device inside the same storage controller in accordance with the cost of power, and a step for migrating the prescribed data between the first storage controller and the second storage controller in accordance with the cost of power.

The elements of the present invention can be constituted either in whole or in part as a computer program. This computer program can be delivered affixed to a storage medium, or can be transmitted via the Internet or some other such communication network.

The first migration plan executed at the first site, the second migration plan, and another first migration plan executed at the second site are able to be executed in cooperation with each other.

### BRIEF DESCRIPTION OF THE DRAWINGS

FIG. 1 is a diagram showing a concept of an embodiment of the present invention;

FIG. 2 is diagrams respectively showing how widely distributed sites are provided, and how the cost of power changes in accordance with regional differences and different time zones;

FIG. 3 is a diagram showing the constitution of a storage system by focusing on a portion of the sites;

FIG. 4 is a diagram showing the overall constitution of one site;

FIG. 5 is a schematic diagram showing an example of storage controller utilization;

FIG. 6 is a diagram showing the constitution of a channel adapter;

FIG. 7 is a diagram showing the constitution of a flash memory controller;

FIG. 8 is a diagram schematically showing the storage hierarchy structure of a storage controller;

FIG. 9 is a diagram showing a mapping table;

FIG. 10 is a diagram showing a configuration management table and a device status management table;

FIG. 11 is a diagram showing an access history management table;

FIG. 12 is a diagram showing a schedule management table;

FIG. 13 is a diagram showing a table for managing a local copy-pair;

FIG. 14 is a diagram showing a table for managing an inter-site copy-pair;

FIG. 15 is a diagram showing a table for managing the line status between sites;

FIG. 16 is a diagram showing a table for managing a user-requested condition;

FIG. 17 is a diagram showing a table for managing the power rates at the respective sites;

FIG. 18 is a diagram schematically showing the relationship between changes in power rates and changes in data storage destinations;

FIG. 19 is a flowchart showing a schedule creation process;

FIG. 20 is a flowchart showing the process for copying data from a disk drive to a flash memory device in advance;

FIG. 21 is a flowchart showing a write process;

FIG. 22 is a flowchart showing a differential-copy process;

FIG. 23 is a flowchart showing a read process;

FIG. 24 is a flowchart showing a data migration process in accordance with a local copy-pair;

FIG. 25 is a diagram showing how a remote copy-pair is configured between sites;

FIG. 26 is a flowchart showing the process for carrying out a remote-copy subsequent to a local-copy;

FIG. 27 is a diagram stagedly showing how copy processes are carried out within a site and between sites;

FIG. 28 is a continuation of the diagram of FIG. 27;

FIG. 29 is a diagram showing a variation of the remote copy-pair;

FIG. 30 is a flowchart showing a copy process, which is executed by a storage system related to a second embodiment;

FIG. 31 is a flowchart showing the details of S120 of FIG. 30;

FIG. 32 is a diagram showing how to select one volume from among a plurality of candidate volumes, and how to carry out a local-copy;

FIG. 33 is a flowchart showing a copy process, which is executed by a storage system related to a third embodiment;

FIG. 34 is a flowchart showing the details of S130 of FIG. 33;

FIG. 35 is a diagram showing how to select one volume from among a plurality of candidate volumes, and how to carry out a remote-copy;

FIG. 36 is a diagram showing how to quantify the merits of the respective candidate volumes, and how to select the candidate volume with the greatest merit based on a plurality of determination indices;

FIG. 37 is a diagram schematically showing the entire constitution of a storage system related to a fourth embodiment;

FIG. 38 is a diagram showing a table for managing a cluster constituted between a plurality of sites;

FIG. 39 is a flowchart showing the process for shifting volume data and a job processing service from a migration-source site to a migration-destination site;

FIG. 40 is a diagram showing the order turning an application program, file system, and volume ON and OFF;

FIG. 41 is a flowchart showing the process for deciding a data storage destination, which is executed by a storage system related to a fifth embodiment;

FIG. 42 is a diagram showing the constitution of a flash memory controller, which is used in a storage system related to a sixth embodiment;

FIG. 43 is a diagram showing the constitution of a flash memory controller, which is used in a storage system related to a seventh embodiment; and

FIG. 44 is a flowchart showing the process for copying data in advance from a disk drive to a flash memory device, which is executed by a storage system related to an eighth embodiment.

### DESCRIPTION OF THE SPECIFIC EMBODIMENTS

The embodiments of the present invention will be explained below based on the figures. In this embodiment, as will be explained in detail hereinbelow, data is migrated within the same site and between sites on the basis of power costs to reduce the total cost of power for the storage system.

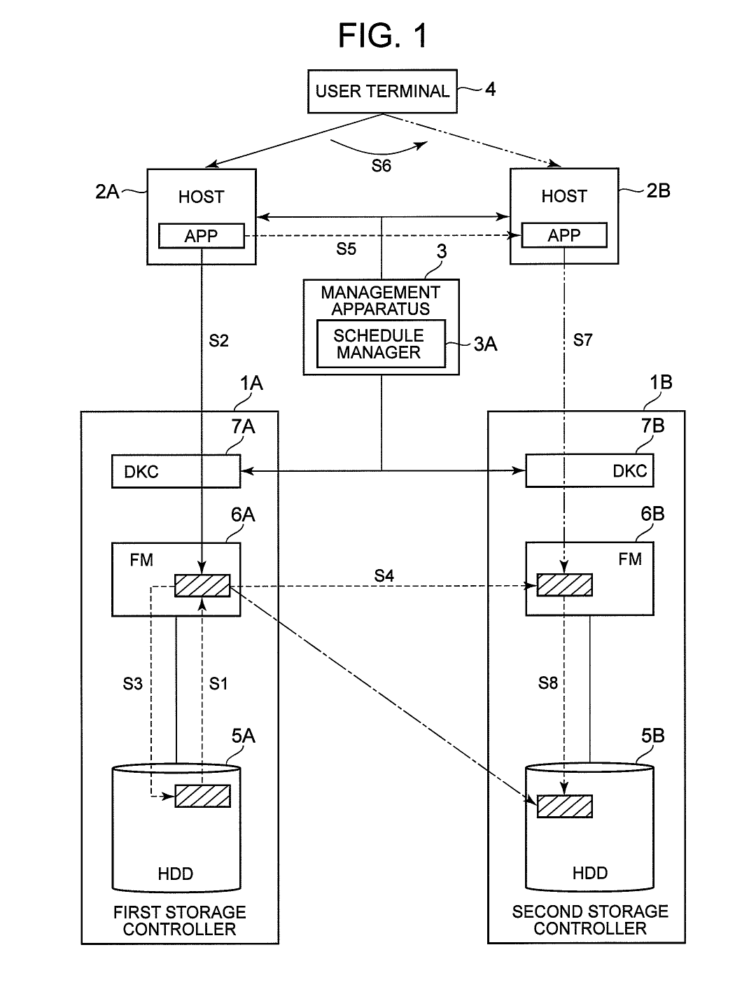

FIG. 1 is a diagram showing the overall concept behind this embodiment. The storage system shown in FIG. 1 comprises a plurality of sites. A first site comprises a storage controller 1A and a host computer (hereinafter, host) 2A. Similarly, a second site comprises a storage controller 1B and a host 2B. Furthermore, the storage system comprises a management apparatus 3 having a schedule manager 3A.

The first site and second site are installed in regions that are physically remote from one another. Placing the respective sites remote from one another makes it possible to withstand wide area disasters and to enhance disaster recovery performance. As a result of installing the respective sites remote from one another, there can be time differences and power rate differences between the sites. Conversely, the installation locations of the respective sites can also be selected such that time differences and power rate differences occur. The power costs of the respective sites will differ according to differences in time and power rates. In this embodiment, the power cost differences of the respective sites are used to hold down the total cost of power for the storage system as a whole by controlling the data destination.

The first storage controller 1A, for example, comprises a hard disk drive 5A, flash memory device 6A and controller 7A. The controller 7A corresponds to the “controller”, and processes the access requests from the host 2A. Further, the controller 7A respectively controls data migration between the hard disk drive 5A and the flash memory device 6A, and data migration between the flash memory device 6A and either the other flash memory device 6B or the other hard disk drive 5B.

The hard disk drive 5A corresponds to the “second storage device”. The hard disk drive 5A, for example, can utilize a FC (Fibre Channel) disk, SCSI (Small Computer System Interface) disk, SATA disk, ATA (AT Attachment) disk, or SAS (Serial Attached SCSI) disk. The hard disk drive 5A is mainly used for stably storing for a long period of time large amounts of data utilized by the host 2A.

The flash memory device 6A corresponds to the “first storage device”. In this embodiment, as a rule, it is supposed that the memory element for storing data is called flash memory, and that the device comprising the flash memory and various mechanisms is called the flash memory device. The various mechanisms, for example, can include a protocol processor, a wear leveling adjustor, and so forth. Wear labeling adjustment is a function for adjusting the number of writes to each cell to achieve a balance. As the flash memory device 6A, either a NAND type or a NOR type flash memory device can be used as deemed appropriate.

The host 2A, for example, is constituted as a computer device, such as a server computer, mainframe computer, workstation, or personal computer. The host 2A and the storage controller 1A, for example, are connected via a communication network, like a SAN (Storage Area Network). The host 2A and the storage controller 1A, for example, carry out two-way communications in accordance with the fibre channel protocol, or the iSCSI (internet Small Computer System Interface) protocol. The host 2A, for example, comprises an application program, such as a database program, and the application program uses data stored in the storage controller 1A.

The second site is constituted the same as the first site. The second storage controller 1B comprises a hard disk drive 5B, flash memory device 6B, and controller 7B, and the controller 7B is connected to the host 2B. Explanations of the hard disk drive 5B, flash memory device 6B, controller 7B and host 2B will be omitted.

Furthermore, in the following explanation, when there is no need to specifically distinguish between the respective sites, the storage controllers 1A, 1B may be referred to generically as storage controller 1, the hosts 2A, 2B may be referred to generically as the host 2, the hard disk drives 5A, 5B may be referred to generically as the hard disk drive 5, the flash memory devices 6A, 6B may be referred to generically as the flash memory device 6, and the controllers 7A, 7B may be referred to generically as the controller 7.

The management apparatus 3, for example, is constituted as a computer device, such as server computer, or a personal computer. The management apparatus 3 collects the internal statuses of the respective storage controllers 1A, 1B, and provides indications to the respective storage controllers 1A, 1B by carrying out communications with the respective controllers 7A, 7B. The respective controllers 7A, 7B can acquire from among the schedules managed by the schedule manager 3A the required scope of information, and can store this information inside the controller. The respective controllers 7A, 7B shift data disposition-destinations based on the schedule.

Information related to a plurality of migration plans is configured in the schedule managed by the schedule manager 3A. The first migration plan is for migrating data between the hard disk drive 5 and flash memory device 6 inside the same storage controller. The second migration plan is for migrating data between respectively different storage controllers. The third migration plan is for switching the host, which will execute the application program.

For example, in the first migration plan, data is copied from the hard disk drive 5 to the flash memory device 6 in advance at night when the cost of power is low, and the flash memory device 6 is used to process access requests from the host 2 in the daytime when the cost of power is high. In the second migration plan, for example, data is copied to a storage controller installed in a low-power-rate region prior to the switchover from the low-power-rate time zone to the high-power-rate time zone.

Furthermore, as will be shown in the embodiments described hereinbelow, the management apparatus can also be provided at each site. In this case, the management apparatuses of the respective sites communicate with one another, and synchronize the contents of respectively managed schedules. Further, as shown in FIG. 1, one management apparatus 3 can also be provided for uniformly managing data migrations inside the storage system. For example, redundancy can also be heightened by creating a management apparatus 3 by configuring a plurality of servers into a cluster.

Further, the constitution can also be such that the schedule manager 3A can be provided in either one or both of the respective hosts 2 and respective storage controllers 1.

The operation of this embodiment will be explained. The controller 7A copies prescribed data stored in the hard disk drive 5A to the flash memory device 6A during the night when the power rate is low, based on the first migration plan inside the schedule (S1).

The prescribed data, for example, is data that will most likely be used by the host 2A. As will become clear from the embodiments described hereinbelow, for example, it is possible to estimate which host will use what information and when by monitoring the utilization status of the storage controller 1A by the host 2A and creating a history thereof.

The prescribed data, which is expected to be used during the daytime, is copied from the hard disk drive 5A to the flash memory device 6A during the night. The host 2A reads out either part or all of the prescribed data copied to the flash memory device 6A, and updates either part or all of the prescribed data copied to the flash memory device 6A (S2).

That is, in this embodiment, it is possible to copy the prescribed data to the flash memory device 6A by operating the high-power-consumption hard disk drive 5A at night when the power rate is low (S1). An access request from the host 2A can be processed using the low-power-consumption flash memory device 6A during the daytime when the power rate is high (S2). Therefore, the power consumption of the entire storage controller 1A can be held down, and power costs can be reduced.

During the daytime, the application program (APP in the figure) of the host 2A provides a job processing service to the user terminal 4. The user terminal 4, for example, is constituted as a personal computer or a mobile computing device (to include a mobile telephone). New data utilized by the user terminal 4 is stored in the flash memory device 6A.

When it becomes that time of day during which the power rate is low, a destage process is carried out to copy the data from the flash memory device 6A to the hard disk drive 5A (S3). Operating the hard disk drive 5A during the low-power-rate time zone does not raise the total power costs of the storage controller 1A that much.

At practically the same time as the destage process is being carried out in the storage controller 1A, the controller 7A can implement a remote-copy to the second storage controller 1B (S4). That is, the storage contents of the flash memory device 6A inside the first storage controller 1A are transferred to and stored in the flash memory device 6B inside the second storage controller 1B.

The provision-source of the job processing service in accordance with the application program can also be switched from host 2A to host 2B (S5). The access-destination of the user terminal 4, which is to use the job processing service, switches from host 2A to host 2B (S6). By making host 2A and host 2B into a cluster, the access destination of the user terminal 4 can be switched without the user terminal 4 being aware of the switch.

In accordance with an access from the user terminal 4, the host 2B accesses the data inside the flash memory device 6B (S7), and provides the job processing service to the user terminal 4. The data inside the flash memory device 6B is stored in the hard disk drive 5B at a prescribed timing (if possible, at the time of day when the power rate is low) (S8).

Furthermore, data can be transferred to and stored in the flash memory device 6B of the second storage controller 1B from the flash memory device 6A of the first storage controller 1A even when the provision-source of the job processing service cannot be switched (S4). The data stored in the flash memory device 6B of the second storage controller 1B is stored in the hard disk drive 5B by taking advantage of the low power rate. Consequently, a data backup can be implemented while curbing the rise in the total power costs of the storage system.

Furthermore, as will become clear from the embodiments described hereinbelow, data can also be transferred to and stored in the hard disk drive 5B of the second storage controller 1B from the flash memory device 6A of the first storage controller 1A.

Furthermore, as will become clear from the embodiments described hereinbelow, logical volumes are respectively configured in the flash memory device 6 and hard disk drive 5, and copying data between the respective logical volumes makes it possible to control the data disposition-destination.

Furthermore, either a total-copy or a differential-copy can be employed as the data copying method. A total-copy is a method for transferring and copying all the data inside the copy-source device to the copy-destination device. A differential-copy is a method for transferring and copying only the difference data between the copy-source device and the copy-destination device to the copy-destination device from the copy-source device. When using a total-copy, it takes time for copying to be completed, but copy control is easy. When using a differential-copy, copying can be completed in a relatively short time, but a mechanism for managing the differences is needed.

In this embodiment, a high-power-consumption hard disk drive 5 can be operated in a time zone or a region for which the power rate is low. Therefore, the total cost of power for the whole storage system can be reduced. This embodiment will be explained in detail below.

### Embodiment 1

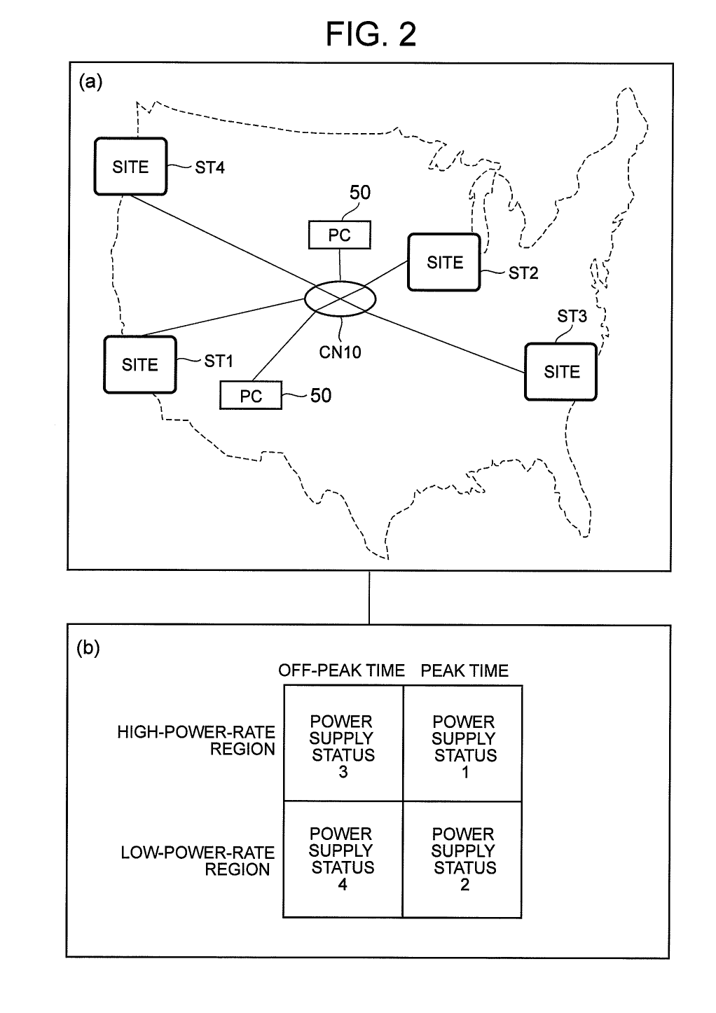

FIG. 2 is a diagram schematically showing the overall constitution of the storage system. As shown in FIG. 2A, this storage system comprises a plurality of sites ST1 through ST4, which are scattered over a wide region. The respective sites ST1 through ST4 are connected to one another via a wide-area communication network CN10, such as the Internet. The user terminals (PC in the figure) 50 can receive job processing services by accessing the nearest site via the communication network CN10. Furthermore, when there is no particular need to distinguish between the respective sites, either the reference numeral will be omitted and the site expressed as “site”, or the site will be called “site ST”.

In FIG. 2B, there is shown a plurality of patterns for the state of the power supply of the storage system. Since the sites can be provided by distributing these sites over a broad region as shown in FIG. 2A, times and power rates will differ in accordance with the locations in which the respective sites are installed. For example, in the example shown in FIG. 2A, time differences corresponding to distances occur between sites ST1, ST4 and sites ST2, ST3. Further, the places where the respective sites are installed could have respectively different power rates. In particular, in a vast nation or union of nations like the United States of America or the European Union, power rates differ greatly by region.

Furthermore, even in the same region, power rates will differ during peak times, when power demand is intense, and off-peak times, when power demand is low. The power rate is set lower during off-peak times than during peak times.

Therefore, as shown in FIG. 2B, power supply status, for example, can be classified into four patterns in accordance with power rate differences by region, and the difference in the power rate at the time of the day when power is being consumed. The first pattern is a situation in which power is consumed during the peak time when the power rate is high in a region where the power rate is high. The second pattern is a situation in which power is consumed during the peak time when the power rate is high in a region where the power rate is low. The third pattern is a situation in which power is consumed during the off-peak time when the power rate is low in a region where the power rate is high. The fourth pattern is a situation in which power is consumed during the off-peak time when the power rate is low in a region where the power rate is low.

The cost of power for the first pattern is higher than the cost of power for the third pattern (first pattern>third pattern), and the cost of power for the second pattern is higher than the cost of power for the fourth pattern (second pattern>fourth pattern). Clearly, the cost of power for the first pattern is the highest, and the cost of power for the fourth pattern is the lowest. Which of the cost of power of the second pattern and the cost of power of the third pattern is higher will depend on circumstances.

The present invention, based on the knowledge described hereinabove, holds down the total power cost of the overall storage system by utilizing the differences in power costs at the respective sites in a widely distributed type storage system.

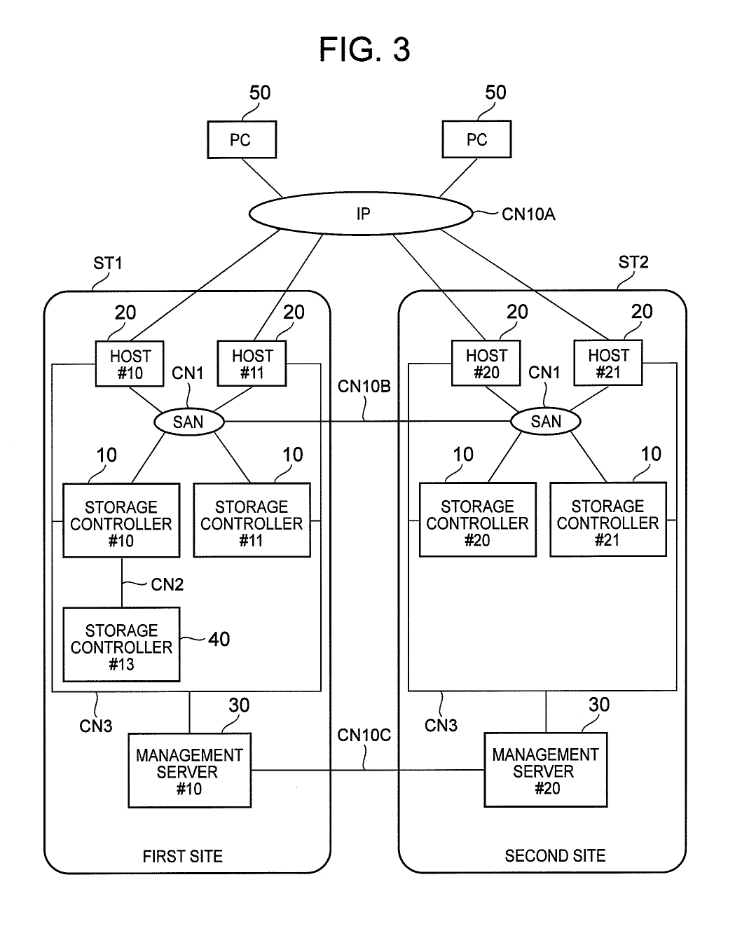

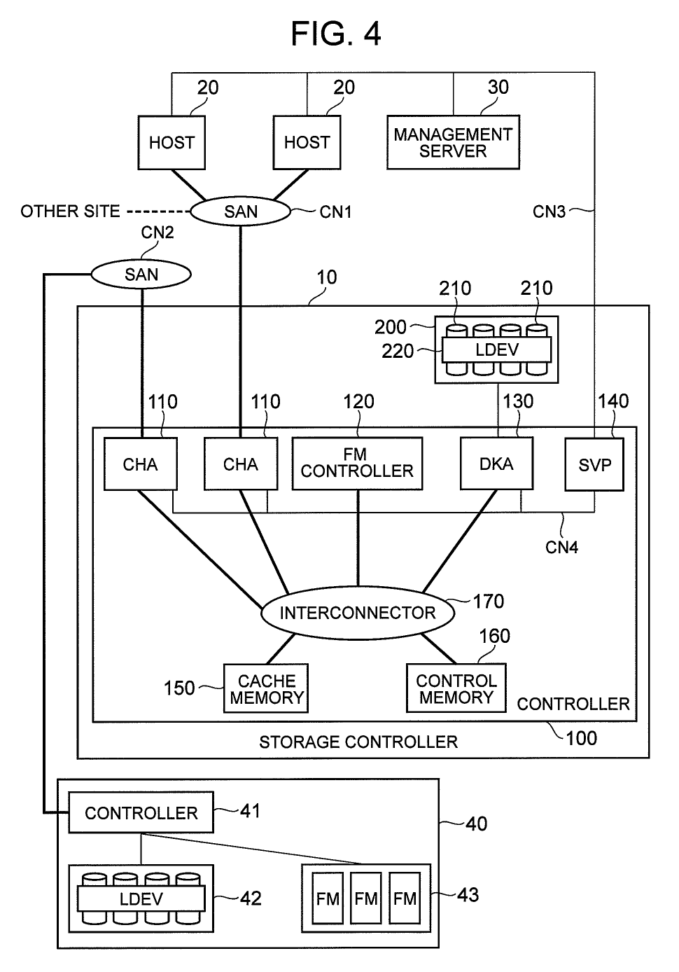

FIG. 3 is a diagram showing an example of a more detailed constitution of the storage system. The corresponding relationship with FIG. 1 above will be explained. The storage controller 10 corresponds to the storage controller 1 in FIG. 1, the host 20 corresponds to the host 2 in FIG. 1, the management server 30 corresponds to the management apparatus 3 in FIG. 1, and the user terminal 50 corresponds to the user terminal 4 in FIG. 1. Further, the hard disk drive 210 in FIG. 4 corresponds to the hard disk drive 5 in FIG. 1, the FM controller (also called a flash memory device) 120 in FIG. 4 corresponds to the flash memory device 6 in FIG. 1, and the controller 100 in FIG. 4 corresponds to the controller 7 in FIG. 1.

Return to FIG. 3. FIG. 3 shows two sites ST1 and ST2 of the plurality of sites shown in FIG. 2.

The first site ST1, for example, comprises a plurality of storage controllers 10, 40, a plurality of hosts 20, and at least one management server 30. Storage controller 40 is called an external storage controller, and provides a storage area of storage controller 40 to storage controller 10 (#10) of the connection destination. The second site ST2, for example, comprises a plurality of storage controllers 10, a plurality of hosts 20, and at least one management server 30.

The connection configuration of the storage system will be explained. First, the connection configuration within a site will be explained. In the respective sites, the respective hosts 20 and respective storage controllers are connected to enable two-way communications via a first intra-site communication network CN1. The external-connection-source storage controller 10 (#10) and the external-connection-destination storage controller 40 are connected to enable two-way communications via a second intra-site communication network CN2. The management server 30 is connected to the respective storage controllers 10 and respective hosts 20 to enable two-way communications via a third intra-site communication network CN3.

The first intra-site communication network CN1 and second intra-site communication network CN2, for example, can be IP_SAN that utilize the IP (Internet Protocol), or FC_SAN that utilize the FCP (Fibre Channel Protocol). The third intra-site communication network CN3, for example, is constituted as a LAN (Local Area Network). Furthermore, the constitution can also be such that the management server 30 and external storage controller 40 are connected to enable two-way communications via the third intra-site communication network CN3 for management use.

The connection configuration between sites will be explained. The respective hosts 20 and the respective user terminals 50 are connected to enable two-way communications via a first inter-site communication network CN10A. The first intra-site communication networks CN1 of the respective sites is connected to enable two-way communications via a second inter-site communication network CN10B. That is, the respective storage controllers 10 at the respective sites are respectively connected via communication networks CN1 and CN10B to enable two-way communications. The management servers 30 are connected via a third inter-site communication network CN10C to enable two-way communications.

The first inter-site communication network CN10A and second inter-site communication network CN10B, for example, are constituted as communication networks such as IP_SAN or FC_SAN. The third inter-site communication network CN10C, for example, is constituted as a communication network such as a LAN or the Internet. The first inter-site communication network CN10A and second inter-site communication network CN10B can be constituted as a single network. Further, the respective inter-site communication networks CN10A, CN10B, CN10C can also be constituted as a single network. However, as shown in FIG. 3, using networks with different purposes makes it possible to prevent the load of one network from affecting the other networks.

FIG. 4 is a block diagram that focuses on the configuration inside one site. Since the external storage controller 40 is a separate storage controller that exists external to the storage controller 10, it will be called the external storage controller in this embodiment. The external storage controller 40 is connected to the storage controller 10 via the second intra-site communication network CN2 for external connection purposes, such as a SAN. Furthermore, the constitution can also be such that the second intra-site communication network CN2 for external connection purposes is done away with, and the storage controller 10 and external storage controller 40 are connected via the first intra-site communication network CN1 for data input/output purposes.

The configuration of the storage controller 10 will be explained. The storage controller 10, for example, comprises a controller 100, and a hard disk mounting unit 200. The controller 100, for example, comprises at least one or more channel adapters 110, at least one or more flash memory device controllers 120, at least one or more disk adapters 130, a service processor 140, a cache memory 150, a control memory 160, and an interconnector 170.

In the following explanation, channel adapter will be abbreviated as CHA, disk adapter will be abbreviated as DKA, flash memory device controller will be abbreviated as FM controller, and service processor will be abbreviated as SVP. Respective pluralities of CHA 110, FM controllers 120, and DKA 130 are provided inside the controller 100.

The CHA 110 is for controlling data communications with the host 20, and, for example, is constituted as a computer apparatus comprising a microprocessor and a local memory. The respective CHA 110 comprise at least one or more communication ports. For example, identification information, such as a WWN (World Wide Name) and IP address, are configured in a communication port. When the host 20 and storage controller 10 carry out data communications using iSCSI or the like, the IP (Internet Protocol) address and other such identification information is configured in the communication port.

Two types of CHA 110 are shown in FIG. 4. The one CHA 110 located in the right side of FIG. 4 is for receiving and processing a command from the host 20, and the communication port thereof becomes the target port. The other CHA 100 located in the left side of FIG. 4 is for issuing a command to the external storage controller 40, and the communication port thereof becomes the initiator port.

The DKA 130 is for controlling data communications with the respective disk drives 210, and similar to the CHA 110, is constituted as a computer apparatus comprising a microprocessor and a local memory.

The DKA 130 and respective disk drives 210, for example, are connected via a communication channel that conforms to the fibre channel protocol. The DKA 130 and respective disk drives 210 transfer data in block units. The channel for the controller 100 to access the respective disk drives 210 is redundant. Should a failure occur in any one of the DKA 130 or communication channels, the controller 100 can use the other DKA 130 or communication channel to access to the disk drives 210. Similarly, the channel between the host 20 and the controller 100, and the channel between the external storage controller 40 and the controller 100 can also be made redundant. Furthermore, the DKA 130 constantly monitors the status of the disk drives 210. The SVP 140 acquires the results of the monitoring by the DKA 130 via an internal network CN4.

The operations of the CHA 110 and DKA 130 will be briefly explained. The CHA 100, upon receiving a read command issued from the host 20, stores this read command in the control memory 160. The DKA 130 constantly references the control memory 160, and upon discovering an unprocessed read command, reads out the data from the disk drive 210, and stores this data in the cache memory 150. The CHA 110 reads out the data, which has been transferred to the cache memory 150, and sends this data to the host 20.

Conversely, upon receiving a write command issued from the host 20, the CHA 110 stores this write command in the control memory 160. Further, the CHA 110 also stores the received write command in the cache memory 150. Subsequent to storing the write command in the cache memory 150, the CHA 110 notifies write-end to the host 20. The DKA 130 reads out the data stored in the cache memory 150 in accordance with the write command stored in the control memory 160, and stores this data in the prescribed disk drive 210.

However, the explanation given above is an example of a situation in which an access request from the host 20 is processed using the disk drive 210. As will be explained hereinbelow, in this embodiment, an access request from the host 20 is processed primarily using the FM controller 120. When the flash memory lacks sufficient free capacity, or when storing data, which has been stored in the flash memory, to the disk drive 210, the data is written to the disk drive 210 by the DKA 130.

The FM controller 120 corresponds to the flash memory device as the “first storage device”. The configuration of the FM controller 120 will also be explained hereinbelow, but the FM controller 120 is equipped with a plurality of flash memories. The FM controller 120 of this embodiment is disposed inside the controller 100. In the embodiments explained hereinbelow, the flash memory device is disposed outside the controller 100. Furthermore, in this embodiment, the flash memory device is given as an example of the first storage device, but the present invention is not limited to this, and if a storage device is rewritable, nonvolatile, and consumes less power than the second storage device, this storage device can apply the present invention.

The SVP 140 is communicably connected to the CHA 110, the FM controller 120, and the DKA 130 via a LAN or other internal network CN4. Further, the SVP 140 is connected to the management server 130 by way of the third intra-site communication network CN3 for management use. The SVP 140 collects information on the various states inside the storage controller 10, and provides this information to the management server 30. The constitution can also be such that the SVP 140 is only connected to either one of the CHA 110 or DKA 130. This is because the SVP 140 can collect the various types of status information via the control memory 160.

The cache memory 150, for example, is for storing data received from the host 20. The cache memory 150, for example, is constituted from a volatile memory. When the cache memory 150 is constituted from a volatile memory, the cache memory 150 is backed up by a battery device. Consequently, even if a power outage should occur, it is possible to secure the time needed for a destage process.

The control memory 160, for example, is constituted as a nonvolatile memory. For example, various types of management information, which will be explained hereinbelow, are stored in the control memory 160. That is, information of a required scope is copied from among the schedule and various tables managed by the management server 30 to the control memory 160. The controller 100 controls the migration of data based on the information copied to the control memory 160.

The control memory 160 and cache memory 150 can be constituted as independent memory boards, or can be provided together on the same memory board. Or, it is also possible to use one portion of the memory as a cache area, and to use the other portion as a control area.

The interconnector 170 interconnects the respective CHA 110, FM controller 120, DKA 130, cache memory 150 and control memory 160. Consequently, all the CHA 110, the DKA 130, the FM controller 120, the cache memory 150 and the control memory 160, respectively, are accessible. The interconnector 170, for example, can be constituted as a crossbar switch.

The constitution of the controller 100 is not limited to the above-described constitution. For example, the constitution can also be such that a function for respectively carrying out data communications with the host 20 and external storage controller 40, a function for carrying out data communications with the flash memory device, a function for carrying out data communications with the disk drive 210, a function for carrying out communications with the management server 30, and a function for temporarily storing data can respectively be provided on one or a plurality of controller boards. Using a controller board like this will make it possible to miniaturize the outside diameter dimensions of the storage controller 10.

The constitution of the hard disk mounting unit 200 will be explained. The hard disk mounting unit 200 comprises a plurality of disk drives 210. The respective disk drives 210 correspond to the “second storage device”. As the disk drives 210, for example, a variety of hard disk drives, such as FC disks, SATA disks, and the like can be used.

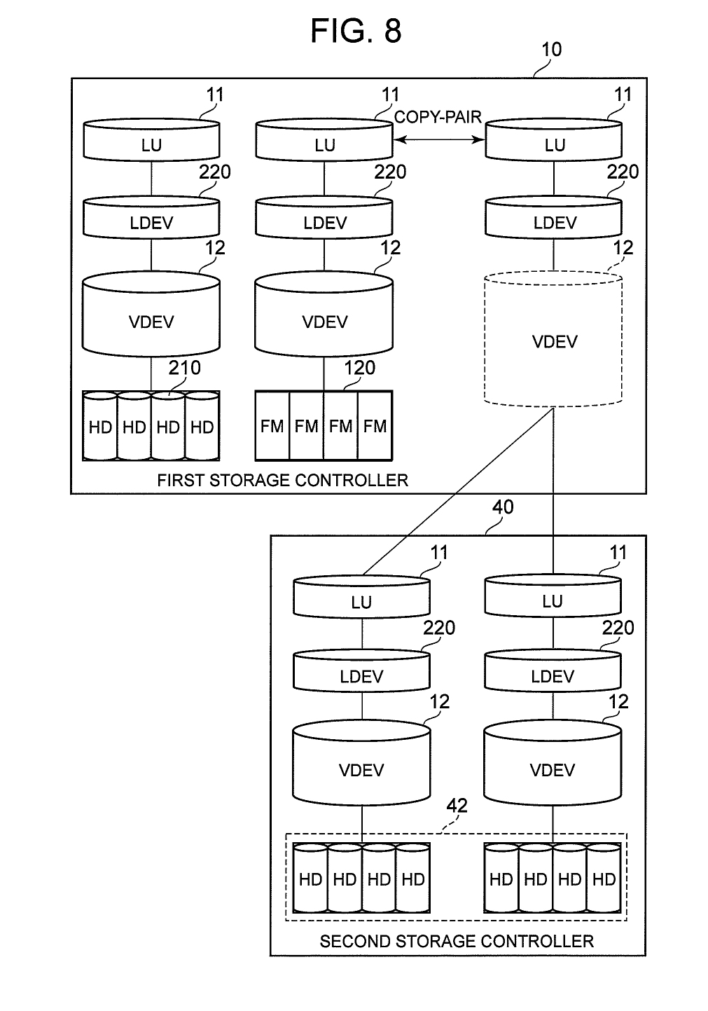

Although it will differ according to the RAID configuration, a parity group is constituted by a prescribed number of disk drives 210, such as a three-drive group or a four-drive group. The parity group is the virtualization of the physical storage areas of the respective disk drives 210 inside the parity group. The parity group is a virtualized physical storage device (VDEV: Virtual DEVice) like that described in FIG. 8.

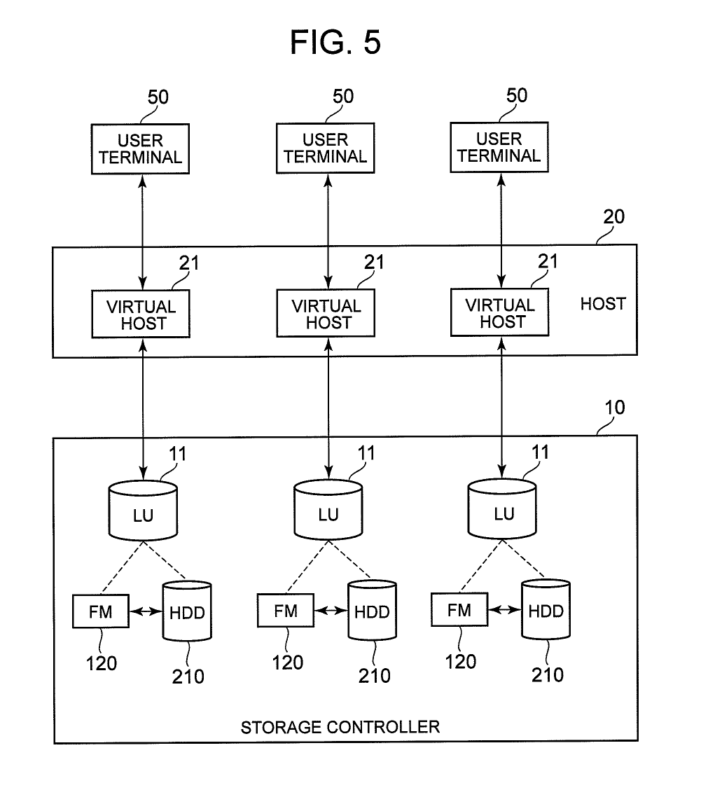

Either one or a plurality of logical devices (LDEV: Logical DEVice) 220 of either a prescribed size or a variable size can be configured in the physical storage area of the parity group. The logical device 220 is a logical storage device, and is made correspondent to a logical volume 11 (refer to FIGS. 5 and 8).

The external storage controller 40, for example, can comprise a controller 41, a hard disk mounting unit 42, and a flash memory device mounting unit 43, similar to the storage controller 10. The controller 41 can use the storage area of a disk drive or the storage area of a flash memory device to create a logical volume.

The external storage controller 40 is called an external storage controller because it resides outside the storage controller 10 as seen from the storage controller 10. Further, the disk drive of the external storage controller 40 can be called the external disk, the flash memory device of the external storage controller 40 can be called the external flash memory device, and the logical volume of the external storage controller 40 can be called the external logical volume, respectively.

For example, the logical volume inside the external storage controller 40 is made correspondent to a virtual logical device (VDEV) disposed inside the storage controller 10 by way of the communication network CN2. Then, a virtual logical volume can be configured on the storage area of the virtual logical device. Therefore, the storage controller 10 can make the host 20 perceive the logical volume (external volume) inside the external storage controller 40 the same as if it were a logical volume inside the storage controller 10 itself.

When an access request is generated to the virtual logical volume, the storage controller 10 converts the access request command for the virtual logical volume to a command for accessing the logical volume inside the external storage controller 40. The converted command is sent to the external storage controller 40 from the storage controller 10 via the communication network CN2. The external storage controller 40 carries out a data read/write in accordance with the command received from the storage controller 10, and returns the result thereof to the storage controller 10.

In this way, the storage controller 10 can make use of a storage resource (logical volume) inside a separate storage controller 40 that exists externally as if it were a storage resource inside the storage controller 10. Therefore, the storage controller 10 does not necessarily have to comprise a disk drive 210 and DKA 130. This is because the storage controller 10 is able to use a storage area provided by a hard disk inside the external storage controller 40. Therefore, the storage controller 10 can be constituted like a high-functionality fibre channel switch and virtualization device, which is equipped with a flash memory.

FIG. 5 is a diagram showing one example of how the storage controller 10 is used. FIG. 4 presented an example of when a plurality of hosts 20, each constituted as independent computer apparatuses, read and write data by accessing the storage controller 10.

By contrast, as shown in FIG. 5, a plurality of virtual hosts 21 can be provided inside a single host 20, and these virtual hosts 21 can read and write data by accessing a logical volume 11 inside the storage controller 10.

A plurality of virtual hosts 21 can be created by virtually dividing the computer resources (CPU execution time, memory, and so forth) of a single host 20. The terminal 50 utilized by the user accesses the virtual host 21 via a communication network, and uses the virtual host 21 to access its own dedicated logical volume 11 configured inside the storage controller 10. The user terminal 50 can comprise the minimum functions necessary for using the virtual host 21.

A logical volume 11, which is made correspondent to the disk drive 210 and flash memory device 120 (hereinafter, the FM controller 120 can be called the flash memory device), is provided inside the storage controller 10. The respective user terminals 50 access the respective user logical volumes 11 by way of the virtual hosts 21. Providing a plurality of virtual hosts 21 inside the host 20 enables the computer resources to be used effectively.

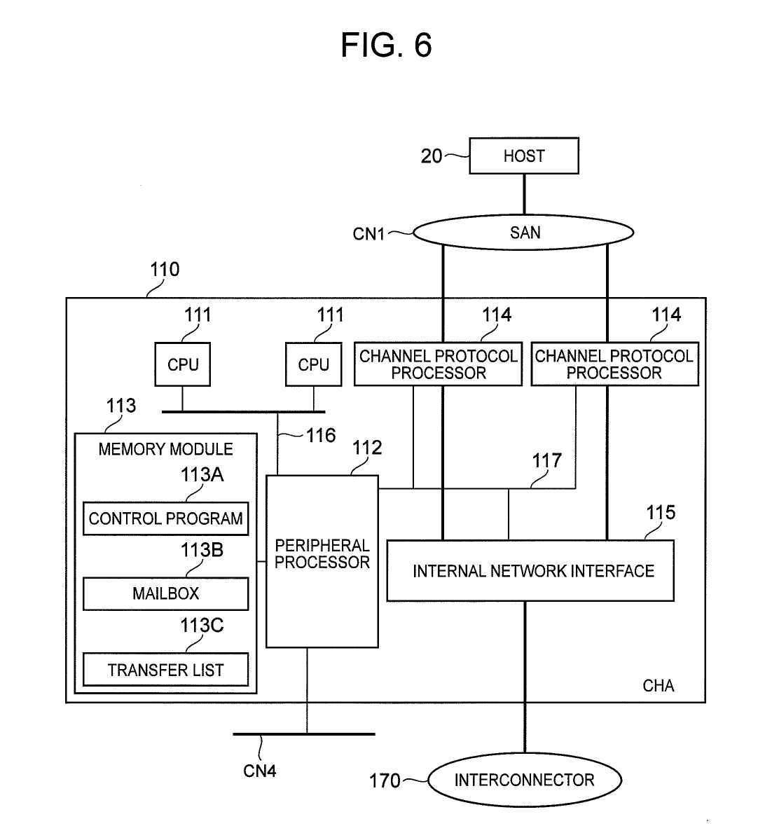

FIG. 6 is a diagram showing the constitution of the CHA 110. The CHA 110, for example, comprises a plurality of microprocessors (CPU) 111, a peripheral processor 112, a memory module 113, a channel protocol processor 114, and an internal network interface 115.

The respective microprocessors 111 are connected to the peripheral processor 112 via a bus 116. The peripheral processor 112 is connected to the memory module 113, and controls the operation of the memory module 113. Furthermore, the peripheral processor 112 is connected to the respective channel protocol processors 114 via a bus 117. The peripheral processor 112 processes packets respectively inputted from the respective microprocessors 111, respective channel protocol processors 114, and internal network interface 115. For example, in the case of a packet for which the transfer destination is the memory module 113, the peripheral processor 112 processes this packet, and, as necessary, returns the processing results to the packet source. The internal network interface 115 is a circuit for communicating with the respective CHA 110, FM controller 120 (flash memory device 120), DKA 130, cache memory 150, and control memory 160 by way of the interconnector 170.

The memory module 113, for example, is provided with a control program 113A, a mailbox 113B, and a transfer list 113C. The respective microprocessors 111 read out and execute the control program 113A. The respective microprocessors 111 carry out communications with the other microprocessors 111 via the mailbox 113B. The transfer list 113C is a list used by the channel protocol processor 114 to carry out DMA (Direct Memory Access).

The channel protocol processor 114 executes processing for carrying out communications with the host 20. The channel protocol processor 114, upon receiving an access request from the host 20, notifies the microprocessor 111 of the number and LUN (Logical Unit Number) for identifying this host 20, and the access-targeted address.

The microprocessor 111, based on the contents notified from the channel protocol processor 114, creates a transfer list 113C for sending the data, which is deemed the target of the read request, to the host 20. The channel protocol processor 114 reads out data from either the cache memory 150 or flash memory device 120 based on the transfer list 113C, and sends this data to the host 20. In the case of a write request, the microprocessor 111 sets the storage-destination address of the data in the transfer list 113C. The channel protocol processor 114 transfers the write data to either the flash memory device 120 or the cache memory 150 on the basis of the transfer list 113C.

Furthermore, although the contents of the control program 113A will differ, the DKA 130 is substantially constituted the same as the CHA 110.

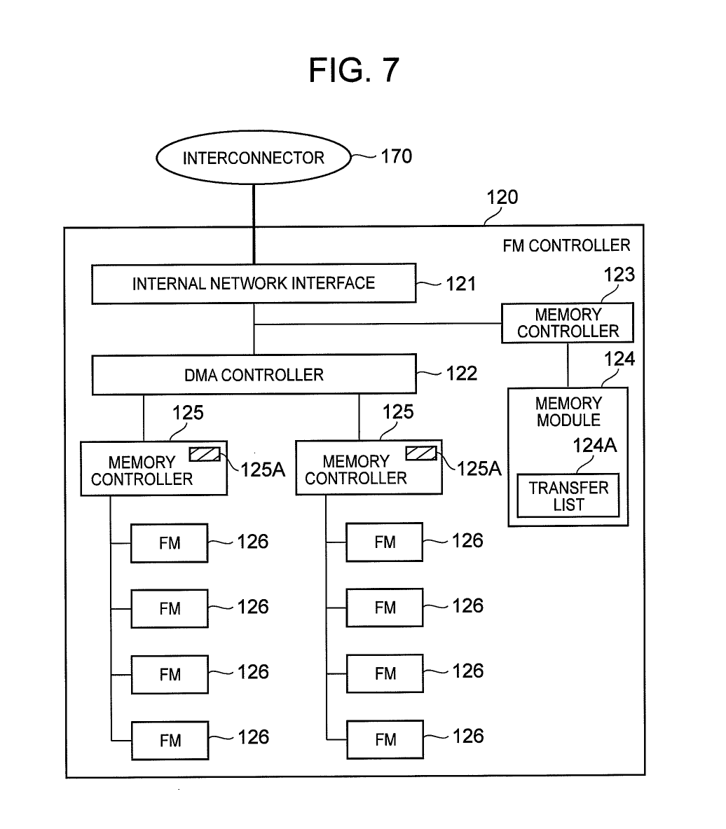

FIG. 7 is a diagram showing the constitution of the FM controller 120. The FM controller 120, for example, comprises an internal network interface 121, DMA controller 122, memory controller 123, memory module 124, memory controllers for flash memory use 125, and flash memories 126.

The internal network interface 121 is a circuit for carrying out communications with the CHA 110, DKA 130, cache memory 150, and control memory 160 by way of the interconnector 170. The DMA controller 122 is a circuit for carrying out a DMA transfer. The memory controller 123 is for controlling the operation of the memory module 124. A transfer list 124A is stored in the memory module 124.

The memory controller for flash memory use 125 is a circuit for controlling the operation of the plurality of flash memories 126. The flash memory 126, for example, is constituted as either a NAND-type or a NOR-type flash memory. The memory controller for flash memory use 125 provides a memory 125A for storing information, such as number of accesses, number of deletions, and so forth related to the respective flash memories 126.

FIG. 8 is a diagram showing the storage hierarchy structure of the storage controller 10. As shown in the left of the top portion of the figure, a virtual intermediate device 12 can be created by virtualizing the physical storage area of the disk drive 210, and a logical device 220 can be provided in the storage area of this intermediate device 12. Configuring a LUN (Logical Unit Number) in the logical device 220 makes it possible to provide a logical volume (LU) 11 to the host 20. Minor differences aside, the logical volume 11 is substantially the same as the logical device 220.

As shown in the center of the upper portion of FIG. 8, an intermediate device 12 can also be provided by virtualizing the physical storage area of the flash memory device 120, and a logical device 220 can also be provided in this intermediate device 12.

As shown by the dotted lines in the right side of FIG. 8, the logical device 220 inside the external storage controller 40 (logical volume 11) can also be made correspondent to the virtual intermediate device 12. The virtual intermediate device 12 uses the storage area inside the external storage controller 40 without there being a physical storage area inside the storage controller 10.

As shown in FIG. 8, the storage contents of the flash memory device and the storage contents of the disk drive can be made to coincide by creating a copy-pair with the logical volume 11 that is dependent on the flash memory device 120 and the logical volume 11 that is dependent on the disk drive.

Furthermore, although omitted from the figure for convenience sake, it is also possible to provide a logical volume 11 inside the external storage controller 40 on the basis of the flash memory device 43. The logical volume based on the flash memory device 43 can also be made correspondent to the virtual intermediate device 12 inside the storage controller 10.

Next, examples of the constitutions of the respective tables utilized in the storage system will be explained. The respective tables described hereinbelow are stored as needed in the control memory 160 inside the controller 100 and the memory inside the management server 30. Furthermore, the specific numerals shown in the respective tables are values arbitrarily configured so as to enable the constitution of the relevant table to be more easily understood, and are not intended to imply consistency among the respective tables.

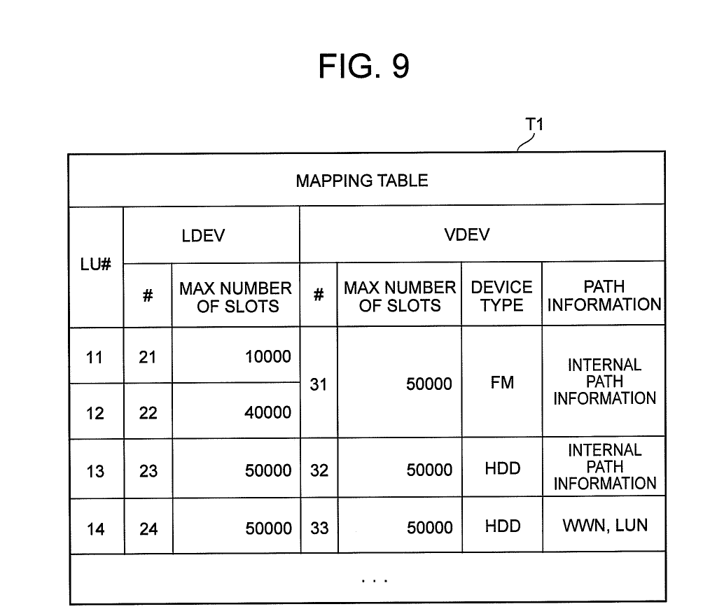

FIG. 9 is a diagram showing one example of a mapping table T1. The mapping table T1 is utilized so that the storage controller 10 can use a logical volume inside the external storage controller 40. This table T1, for example, is stored in the control memory 160.

The mapping table T1, for example, can be configured by making the LUN (LU# in the figure), the number for identifying the logical device (LDEV), and the number for identifying the intermediate device (VDEV) correspondent.

Information for identifying the intermediate device, for example, can comprise the intermediate device number; information showing the type of the physical storage device to which the intermediate device is connected; and routing information for connecting to the physical storage device. Internal path information for accessing either the flash memory device 120 or the disk drive 210 is configured when the intermediate device 12 has been made correspondent to either the flash memory device 120 or disk drive 210 inside the storage controller 10.

When the intermediate device 12 is connected to the logical volume inside the external storage controller 40, external path information needed to access this logical volume is configured. The external path information, for example, comprises a WWN, LUN and the like. The controller 100 of the storage controller 10 converts a command received from the host 20 to a command to be sent to the external storage controller 40 by referencing the mapping table T1.

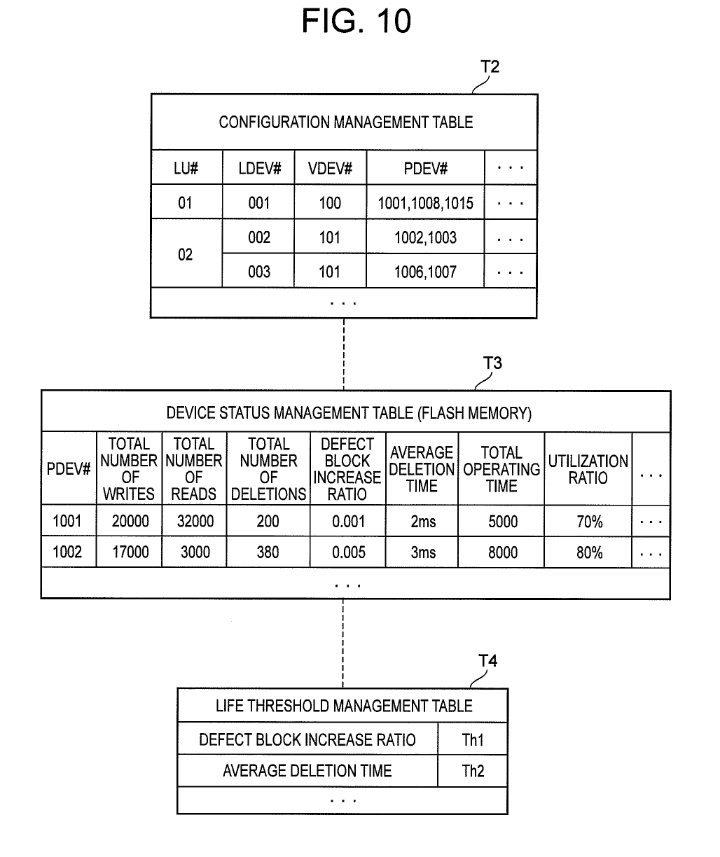

FIG. 10 is a diagram respectively showing examples of the constitutions of a configuration management table T2, device status management table T3, and life threshold management table T4. The respective tables T2, T3, T4 are stored in the control memory 160.

The configuration management table T2 is for managing the configuration of the logical volume under the management of the storage controller 10. The configuration management table T2, for example, manages the number (LU#) for identifying the logical volume; the number (LDEV#) for identifying the logical device correspondent to this logical volume; the number (VDEV#) for identifying the intermediate device correspondent to this logical device; and the number (PDEV#) for identifying the physical storage device correspondent to this intermediate device.

The LU, LDEV and VDEV can be mapped on the PDEV constituted from the disk drive 210, and, as described in FIG. 8, the LU, LDEV, and VDEV can also be mapped on the flash memory device 120.

The device status management table T3 is for managing the status of the physical storage device. FIG. 10 shows a table for managing the status of the flash memory device as the physical storage device.

For example, Table T3, which manages the status of the flash memory device, correspondently manages the number (PDEV#) for identifying this flash memory device; the total number of times data has been written to this flash memory device; the total number of times data has been read from this flash memory device; the total number of times data stored in this flash memory device has been deleted; the rate of increase in defective blocks occurring in this flash memory device; the average time required to delete data stored in this flash memory device; the cumulative time that this flash memory has been operated; and the utilization ratio of this flash memory (utilization ratio=amount of stored data/flash memory storage capacity).

Due to the physical constitution of the cells of the flash memory, an upper limit can be configured for the number of writes. Therefore, managing the cumulative value of the number of writes (total number of writes) makes it possible to infer the residual life of this flash memory device. Similarly, it can be supposed that residual life has become minimal when the value of the defective block increase rate of the flash memory device increases and/or the average deletion time becomes longer, and to the extent that the total operating time increases.

The respective life estimation parameters mentioned above are just an example, and the present invention is not limited to these. Furthermore, since residual life can also be considered as the degree of reliability of the flash memory device, the life estimation parameters can also be called parameters for determining reliability.

The life threshold management table T4 is for managing the life threshold for detecting when the residual life of the flash memory device has become minimal. Life thresholds Th 1, Th 2, . . . are configured beforehand in the life threshold management table T4 for each of the above-mentioned life estimation parameters (total number of writes, defective block increase rate, average deletion time, and so forth).

Furthermore, the same also holds true for the disk drive, and, for example, the life of this disk drive can be estimated by collecting the total number of accesses, total number of writes, number of defective blocks, defective block increase rate, number of times the power has been turned ON/OFF, and total operating time.

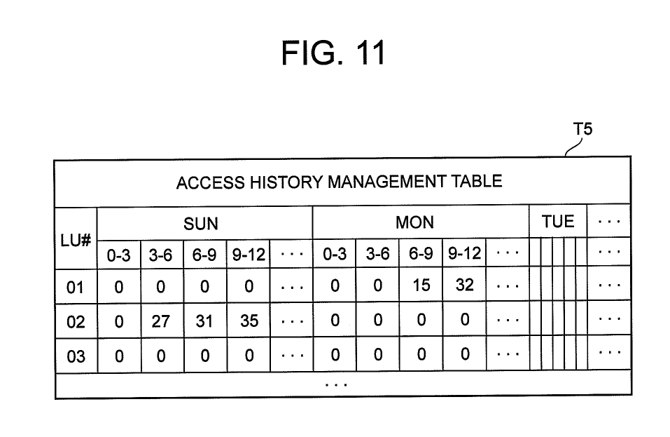

FIG. 11 is a diagram showing an example of the constitution of an access history management table T5. This table T5 can be stored in both the memory inside the management server 30 and the control memory 160 inside the storage controller 10.

The access history management table T5 is for managing the history of accesses for each logical volume. For example, the access history management table T5 can respectively manage the number of accesses to the respective logical volumes for each time zone of each day. In FIG. 11, it appears as if no distinction is made between a write access and a read access, but, in reality, the number of accesses for each hour of each day is detected and recorded for write accesses and read accesses, respectively. Table T5 can also be constituted such that the amount of data per access (number of logical blocks) is recorded at the same time.

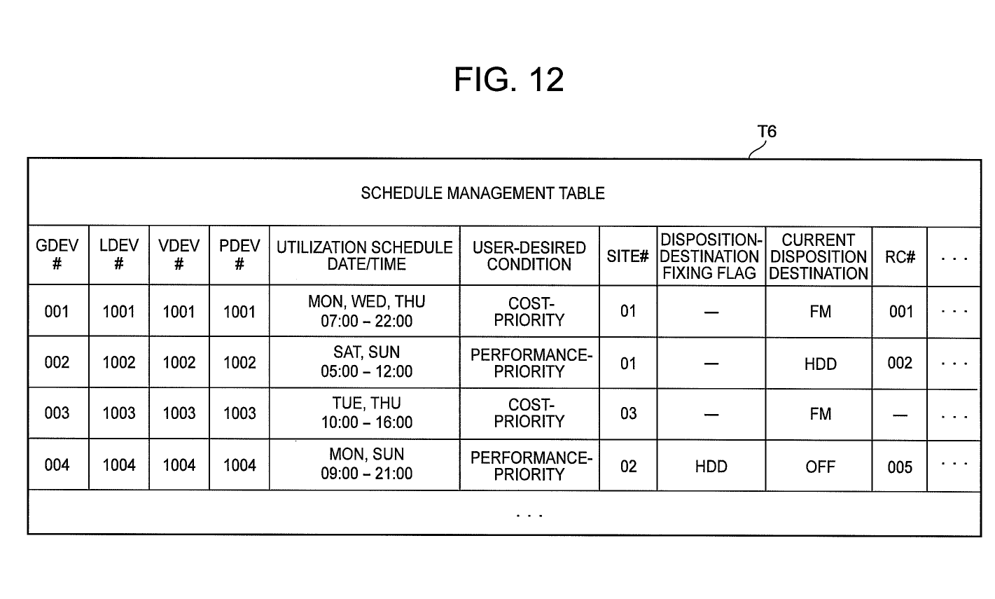

FIG. 12 is a diagram showing an example of a schedule management table T6. This table T6 can be stored in both the memory inside the management server 30, and the control memory 160 inside the storage controller 10.

The schedule management table T6 is for managing the utilization schedules of the respective logical volumes. The schedule management table T6, for example, correspondently manages a global device number (GDEV#); a logical device number (LDEV#); an intermediate device number (VDEV#); a physical device number (PDEV#); a utilization schedule date/time; a user desired condition; a site number; disposition-destination fixing flag; a current disposition-destination; and remote copy number (RC#).

A global device number is identification information for uniquely specifying logical volumes inside the respective widely distributed sites. When the global device number is not utilized, the site number, controller number (DKC#) and logical device number can be used to uniquely specify the logical volumes inside the storage system.

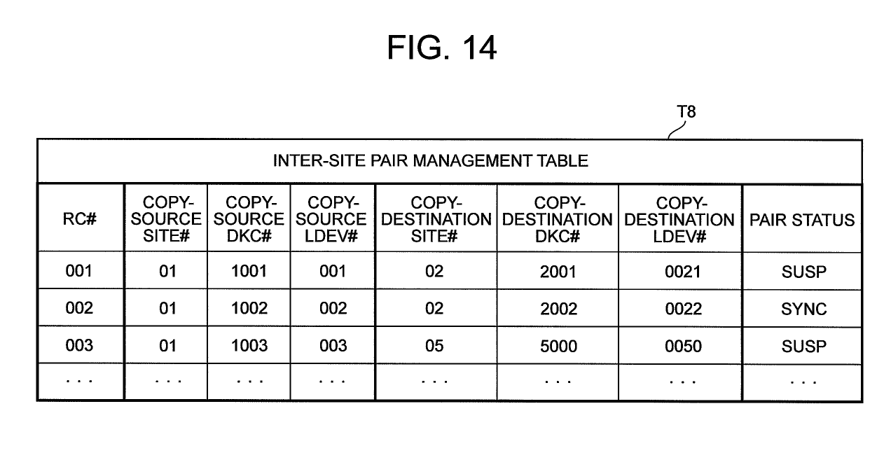

In this embodiment, the method for identifying the respective logical volumes inside the storage system via a global device number as shown in FIG. 12, and the method for identifying the respective logical volumes inside the storage system via the site number, controller number, and logical device number as shown in FIG. 14, are both given. Either one of these methods can be used.

The “utilization schedule date/time” is information showing the date and time that the user is scheduled to use a logical volume, and can be automatically configured by the management server 30 based on the access history stored in the access history management table T5. The user can also manually revise an automatically configured utilization schedule date/time.

The “user desired condition” is information showing the condition desired when the user uses a logical volume, and, for example, either “cost priority” or “performance priority” can be configured. Cost priority is a mode that places priority on lowering power costs. When the cost priority mode is selected, the data storage destination of a logical volume is controlled so as to reduce total power consumption as much as possible when using this logical volume. That is, when the cost priority mode is selected, the disk drive in which the data of this logical volume is stored is driven as much as possible during the low-power-rate time zone.

Performance priority is a mode that places priority on maintaining access performance. When the performance priority mode is selected, the data storage destination of a logical volume is controlled so as to keep up response performance as much as possible when using this logical volume.

In this embodiment, as will be explained below, the fact that nighttime power rates are low is used to advantage to copy at least a portion of the data inside a logical volume in advance from a disk drive 210 (This includes external disks. The same holds true below) to a flash memory device 120 (This includes external flash memory devices. The same holds true below) in preparation for this data being used by the user the next day. Consequently, it is possible to process an access request from the host 20 using a low-power-consumption flash memory device during the daytime when the power rate is high.

When the amount of data copied from the disk drive 210 to the flash memory device 120 is small, all copy-targeted data can be copied from the disk drive 210 to the flash memory device 120 during the nighttime when the power rate is low. However, the storage controller 10 manages data being used by a large number of users, and the amount of data used by the respective users is steadily increasing.

Therefore, there could be times when it is not possible to complete copying of all the copy-targeted data in the time zone, when the power rate is low. In a case like this, if priority is being placed on power costs, it may be better to end copying part way through, and shut down the operation of the disk drive 210. This is because operating the disk drive 210, which is the copy-source device, in the high-power-rate time zone increases the cost of power for this logical volume.

By contrast, if priority is being placed on access performance over power costs, it is probably better to continue copying from the disk drive 210 to the flash memory device 120 even after transitioning to the high-power-rate time zone, and to store all the copy-targeted data in the flash memory device 120. Generally speaking, the data read and write speeds of the flash memory device 120 are superior to those of the disk drive 210.

The “disposition-destination fixing flag” is information for affixing the data storage destination of the logical volume. When “HDD” is configured in the disposition-destination fixing flag, this data storage destination is fixed in the disk drive 210. Therefore, data for which “HDD” has been configured is not copied to a flash memory device.

The “current disposition destination” is information for specifying the storage device in which the logical volume data is stored. When “FM” is configured in the current disposition destination, this data is stored in the flash memory device. When “HDD” is configured in the current disposition destination, this data is stored in the disk drive 210. Disposition-destination information can comprise identification information (PDEV#) for specifying a storage device, as well as the type of storage device.

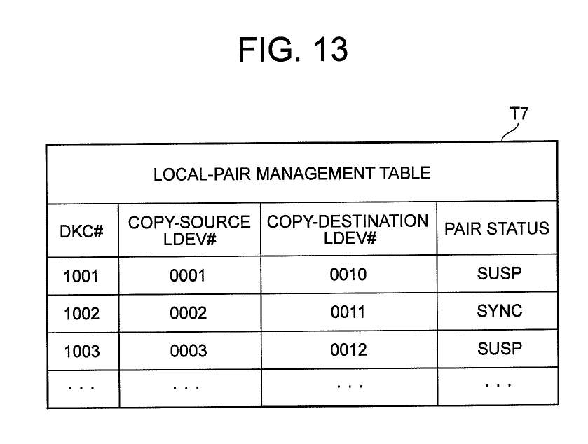

FIG. 13 is a diagram showing an example of the constitution of a local-pair management table T7. A local-pair is a copy-pair that is created by two logical volumes residing inside the same storage controller 10. In this embodiment, a copy-pair is created by a logical volume 11 (FS), which is created based on the flash memory device 120, and a logical volume 11 (HDD), which is created based on the disk drive 210. Therefore, the storage contents are synchronized by an inter-volume copy between the flash memory device 120 and the disk drive 210.

The local-pair management table T7, for example, correspondently manages a controller number (DKC#); a copy-source volume number (copy-source LDEV#); a copy-destination volume number (copy-destination LDEV#); and a copy status. Furthermore, in addition to this, for example, an item, such as a local-pair number for identifying the respective local-pairs, can also be added to the table T7.

The controller number is information for identifying the storage controller 10 provided in a site. Because a plurality of storage controllers 10 can be provided in the respective sites, table T7 manages the controller numbers. The copy-source volume number is information for identifying the volume that constitutes the copy-source. The copy-destination volume number is information for identifying the volume that constitutes the copy-destination.

The pair status is information showing the status of a copy-pair. In pair status, for example, there is a suspend state (“SUSP” in the figure) and a synchronize state (“SYNC” in the figure). The suspend state is a state in which the copy-source volume and copy-destination volume are separated. The synchronize state is a state in which the copy-source volume and the copy-destination volume create a copy-pair, and the contents of both volumes coincide.

FIG. 14 is a diagram showing an example of the constitution of an inter-site pair management table T8. The inter-site pair management table T8 is for managing a copy-pair provided between a migration-source site (copy-source site) and a migration-destination site (copy-destination site).

In this embodiment, data is copied between remotely separated sites in order to use the disk drive 210 in a region, where the cost of power is low, and at a time of day when the cost of power is low. This inter-site data copy (also called a remote-copy) is realized by synchronizing the volumes provided at the respective sites.

The inter-site pair management table T8, for example, can correspondently constitute information for identifying a remote-copy; information for identifying a copy-source; information for identifying a copy-destination; and information for identifying a pair status.

The remote-copy number (RC#) is information for respectively identifying remote copies configured between the respective sites. Information for identifying a copy-source, for example, comprises a copy-source site number; a copy-source controller number; and a copy-source volume number. The copy-source site number is information for identifying the site, which has the copy-source volume. The copy-source controller number is information for identifying the controller, which manages the copy-source volume.

The information for identifying the copy-destination comprises the same information as that for identifying the copy source, for example, a copy-destination site number; a copy-destination controller number; and a copy-destination volume number. The copy-destination site number is information for identifying the site having the copy-destination volume. The copy-destination controller number is information for identifying the controller, which manages the copy-destination volume.

The pair status is information showing the status of a remote-copy. The pair status, as described hereinabove, comprises the suspend state and the synchronize state. Migration-targeted data is remote copied between a plurality of sites inside the storage system using the table T8 shown in FIG. 14.

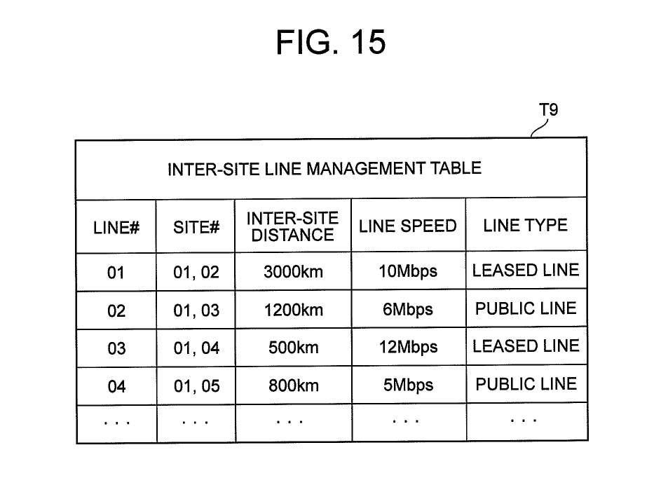

FIG. 15 is a diagram showing an example of the constitution of an inter-site line management table T9. The inter-site line management table T9 is for managing the status of a line established between respective sites. The inter-site line management table T9, for example, correspondently manages a line number; a site number; an inter-site distance; a line speed; and a line type.

The line number is information for identifying the respective lines interconnecting the respective sites within the storage system. The site number is information for respectively identifying the two sites, which are connected by this line. Inter-site distance shows the physical distance between the two sites connected by this line. The line speed shows the communication speed of this line. The line type shows the type of this line. The types of lines, for example, are leased lines and public lines.

By multiplying the size of the migration-targeted data by the line speed, it is possible to determine the time required for the migration of this migration-targeted data to be completed.

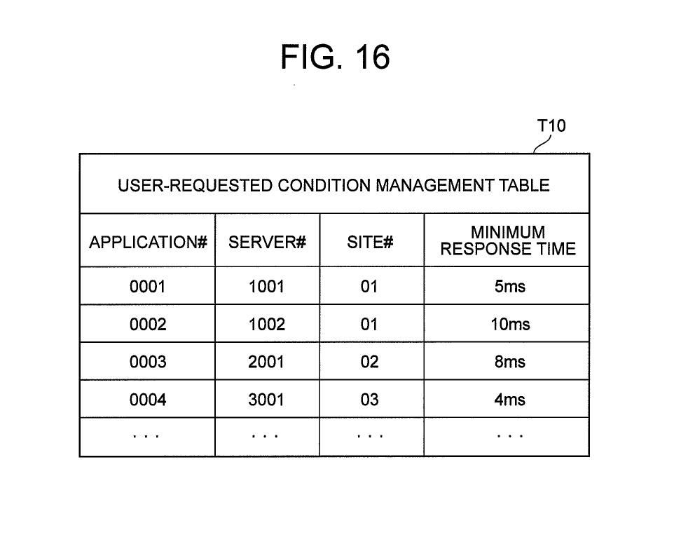

FIG. 16 is a diagram showing an example of the constitution of a user-requested condition management table T10. This table T10 is for managing a condition requested by the user. In this embodiment, the provision-source of a job processing service, which uses data, can also be changed pursuant to migrating this data between sites. This table T10 records the user condition related to changing the provision-source of the job processing service.

Therefore, the user-requested condition management table T10, for example, correspondently manages an application number; a server number; a site number; and a minimum response time. The application number is information for identifying the various job processing services provided within the storage system. The server number is information for identifying the host, which provides this job processing service. The site number is information for identifying the site of the host, which provides the job processing service. The minimum response time shows the minimum response time requested by the user for this job processing service.

Although there will be differences according to the speed of the communication line and the performance of the storage controller 10, the response time tends to increase the further apart the site providing the job processing service is from the user terminal 50 using this job processing service. This is due to increased communication delay time. Accordingly, in this embodiment, the user can configure beforehand in the table T10 a minimum response time during which the job processing service should be realized.

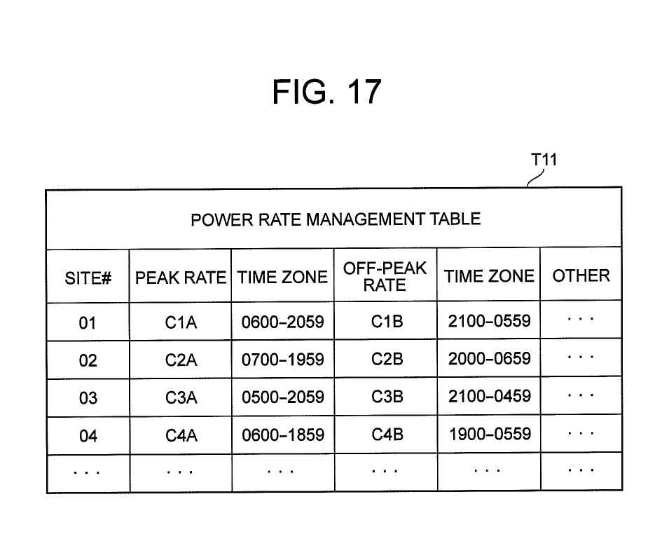

FIG. 17 is a diagram showing an example of the constitution of a power rate management table T11. This table T11 manages the power rates of the respective sites. The power rate management table T11, for example, correspondently manages a site number; a peak power rate; a peak time zone; an off-peak power rate; an off-peak time zone; and other information.

The highest power rate, such as the power rate applied in the daytime, for example, is configured in the peak power rate. The peak time zone is information showing the time of day when the peak rate is applied. The lowest power rate, such as the power rate applied in the nighttime, for example, is configured in the off-peak power rate. The off-peak time zone is information showing the time of day when the off-peak rate is applied. The other information, for example, can include the name of the power company that supplies power to a site; information showing seasonal fluctuations when the power rate changes according to the season; and information related to contract options.

The power rate management table T11 can be configured under the guidance of either the storage system administrator or the administrators of the respective sites. For example, when power companies in the respective regions release power rate and other such information over communication networks, the management server 30 can acquire the power rate and other information from the servers of these respective power companies, and record this information in table T11.

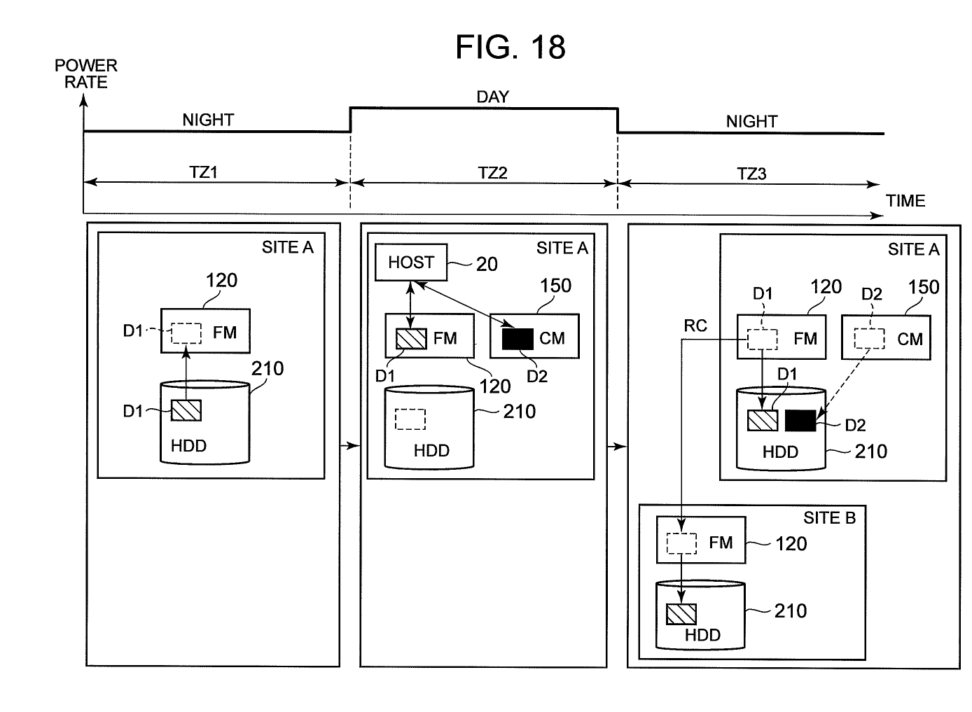

FIG. 18 is a diagram schematically showing the operation of the storage system in accordance with this embodiment. The upper portion of FIG. 18 shows the changes in the power rate, and the bottom portion of FIG. 18 shows the changes in data storage destinations.

During the night TZ1 of a certain day, the power rate of site A is low. In this nighttime time zone TZ1, the prescribed data D1 stored in the disk drive 210 of site A is copied to the flash memory device 120. That is, a staging process is carried out from the disk drive 210 to the flash memory device 120 in time zone TZ1, when the power rate is low.

During the daytime TZ2 of the next day, the power rate of site A is high. In this daytime time zone TZ2, the host 20 uses the storage controller 10. There are exceptions, but working hours are mostly established in the daytime time zone TZ2. Therefore, the host 20 accesses the logical volume during working hours. As described above, at least one part (D1) of the data to be accessed by the host 20 is copied beforehand to the flash memory device 120 before the host 20 starts to use the storage controller 10.

Therefore, at least one part of the access request from the host 20 is processed using the data D1 stored in the flash memory device 120. The flash memory device 120 consumes less power than the disk drive 210. Therefore, the power costs of the storage controller 10 can be reduced in proportion to the extent the access requests from the host 20 are processed using the flash memory device 120.

Furthermore, during the daytime TZ2, when the power rate is high, the disk drive 210 is placed into a spin-down state since there are few occasions for it to be used. In order to further reduce daytime TZ2 power costs, the constitution can be such that either power is completely shut off to the disk drive 210 storing the prescribed data D1, or power to the hard disk mounting unit 200 is reduced or shut off. Furthermore, when using the disk drive inside the external storage controller 40, the constitution can be such that power to the external storage controller 40 is either cut back or shut off.

In the daytime time zone TZ2, when the free capacity of the flash memory device 120 becomes scarce due to an update request from the host 20, write-data D2 received from the host 20 can also be stored in the cache memory 150. Furthermore, when a read of data other than the data D1 that has been copied to the flash memory device 120 is requested by the host 20, the storage controller 10 operates the disk drive 210 and reads the data that the host 20 requested.

When the daytime time zone TZ2 ends, site A transitions to the nighttime time zone TZ3, when the power rate is low. In the nighttime time zone TZ3, both a local-copy within site A and a remote-copy between site A and site B are respectively implemented.

In the local-copy inside site A, the data D1 updated in the daytime time zone TZ2 is copied from the flash memory device 120 to the disk drive 210. This local-copy copies only the differences between the data D1 inside the flash memory device 120 and the data D1 inside the disk drive 210 from the flash memory device 120 to the disk drive 210. Furthermore, when data D2 has been stored in the cache memory 150 inside site A, this data D2 is also copied from the cache memory 150 to the disk drive 210 in the nighttime time zone TZ3.

In the nighttime time zone TZ3, data D1 is remote copied from the flash memory device 120 of site A to the flash memory device 120 of site B. Furthermore, although omitted from the figure, when data D2 is stored in the cache memory 150 of site A, this data D2 can also be remote copied to the flash memory device 120 of site B.

In site B, the data D1 received from site A is stored in the flash memory device 120 of site B. Furthermore, in site B, the data D1 stored in the flash memory device 120 of site B can be destaged to the disk drive 210 of site B.

The copy of the data D1 managed in site A can be disposed inside site B by a remote copy from site A to site B. The protection of the data D1 can be made redundant by the data D1 stored inside site B. Or, the host 20 of site B can use the data D1 stored in site B to provide a job processing service to the user terminal 50.

When the power rate of site B is lower than the power rate of site A, a backup can be provided at a lower cost than providing a backup of the data D1 inside site A, and disaster recovery performance can be enhanced.

There is a big time difference between site A and site B, and when it is nighttime at site A, it is daytime at site B. In this case, if the daytime power rate of site B is lower than or equivalent to the nighttime power rate of site A, it is possible to curb an increase in the cost of power for the storage system as a whole even when operating the disk drive 210 inside site B.

As described hereinabove, in this embodiment, a staging process is executed from the disk drive 210 to the flash memory device 120 in the low-power-rate time zone TZ1 prior to the provision of a job processing service being provided in the local site where the job processing service is primarily provided, and an access request from the host 20 is processed using the low-power-consumption flash memory device 120 during working hours TZ2 when the power rate is high. Then, a destaging process is executed from the flash memory device 120 to the disk drive 210 in the low-power-rate time zone TZ3 subsequent to job completion. Therefore, because the high-power-consumption disk drive 210 is operated primarily in the low-power-rate time zones TZ1 and TZ3, the power costs of the storage controller 10 can be lowered.

Furthermore, in this embodiment, an increase in power costs for the storage system as a whole can be held in check, and a backup can be generated by remote copying the data to another site B with a different power rate.

Furthermore, inter-site remote-copy processing and processing for switching the source of job processing service provision between sites will be explained in detail in other embodiments.

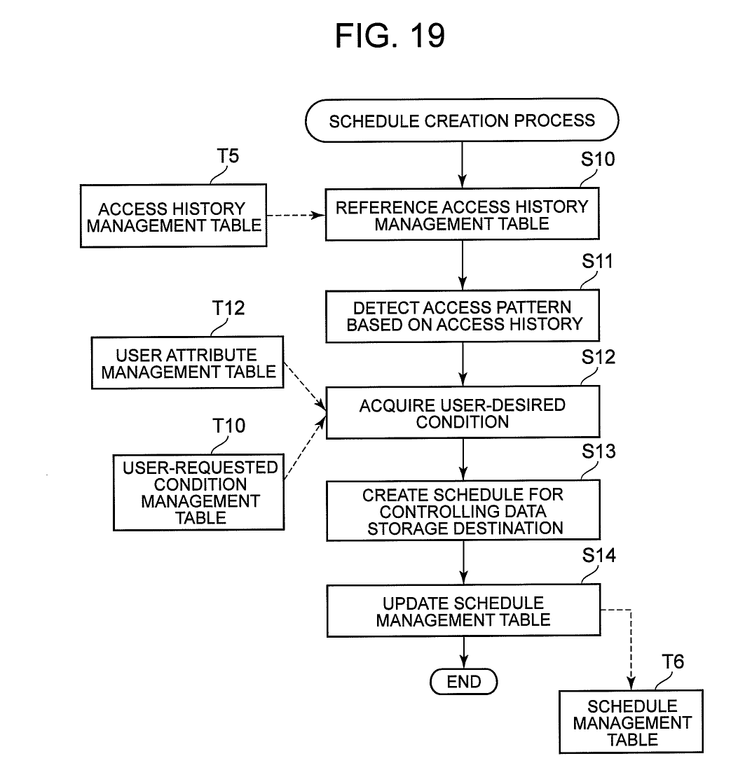

The operation of the storage system in accordance with this embodiment will be explained based on FIGS. 19 through 23. Furthermore, the respective flowcharts shown hereinbelow show overviews of the respective processes to the extent necessary for understanding and implementing the present invention, and may differ from the actual computer programs. A so-called person having ordinary skill in the art should be able to delete or change the steps shown in the figures.

FIG. 19 is a flowchart showing the process for creating a schedule for controlling the data storage destination. The schedule creation process can be executed by the storage controller that implements the created schedule, and can also be executed by the management server 30. A case in which the schedule creation process is executed by the management server 30 will be explained here. The management server 30 can collect and manage access histories from the respective storage controllers 10 inside a site.

The management server 30 references the access history management table T5 (S10), and detects an access pattern based on the access history (S11). The access pattern is information for classifying when and how often this logical volume is accessed.

The management server 30 acquires a user-desired condition (S12). The user can manually select either “cost priority” or “performance priority”. Or, the management server 30 can also automatically configure a user-desired condition based on a user attribute management table T12. For example, the section, position, and job content of the user, who is using the logical volume, can be configured in the user attribute management table T12.

The management server 30 creates a schedule by executing S10 through S12 (S13), and updates the schedule management table T6 (S5). Furthermore, the constitution can also be such that the user can check the created schedule and revise the schedule manually. When the provision-source of the job processing service changes in accordance with a data migration, the management server 30 uses the user-requested condition management table T10 to create the schedule.

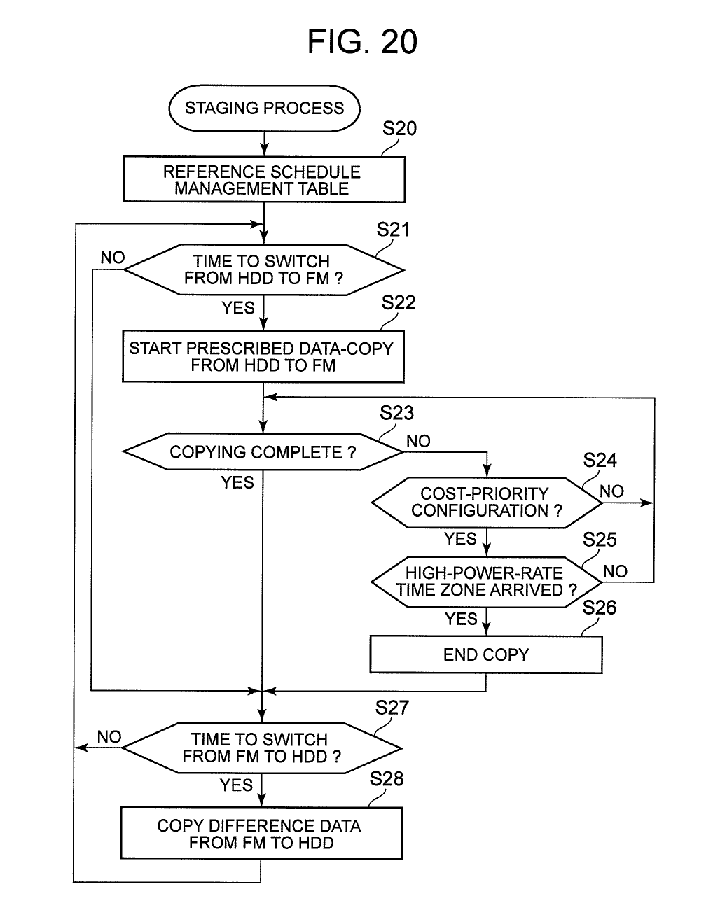

FIG. 20 is a flowchart showing the process (staging process) for copying the prescribed data in advance from the disk drive 210 to the flash memory device 120 inside the same storage controller 10.

The storage controller 10 references the schedule management table T6 (S20), and determines whether or not the time for switching the data storage destination from the disk drive 210 to the flash memory device 120 has arrived (S21).

For example, when the user is scheduled to use the logical volume beginning Monday morning, a time, which takes into account the time required for a data copy, is selected as the switching time (that is, the staging start time) in the low-power-rate time zone prior to the user commencing work.

When it is determined that the switching time has arrived (S21: YES), the storage controller 10 begins copying the prescribed data from the disk drive 210 to the flash memory device 120 (S22). The prescribed data can be all the data in the logical volume, or data of a prescribed amount from the beginning of the logical volume. Or, the prescribed data can be a prescribed amount of data, which has a relatively new update time, from among the data stored in the logical volume.

The storage controller 10 determines whether or not the data-copy from the disk drive 210 to the flash memory device 120 is complete (S23). When the data-copy is not complete (S23: NO), the storage controller 10 determines whether or not the user-desired condition is “cost priority” (S24).

When the user-desired condition is cost priority (S24: YES), the storage controller 10 determines whether or not the high-power-rate time zone (typically, daytime) has arrived (S25). When the high-power-rate time zone has arrived (S25: YES), the storage controller 10 finishes copying the data from the disk drive 210 to the flash memory device 120 (S26). By contrast, when the user-desired condition is “performance priority” (S24: NO), or when execution is not being carried out in a high-power-rate time zone (S25: NO), processing returns to S23.

When the data-copy from the disk drive 210 to the flash memory device 120 is complete (S23: YES), the storage controller 10 stands by until the time for switching the data storage destination from the flash memory device 120 to the disk drive 210 (that is, the destage start time) arrives (S27).

When the time for copying the data from the flash memory device 120 to the disk drive 210 has arrived (S27: YES), the storage controller 10 copies the differences between the data stored in the flash memory device 120 and the data stored in the disk drive 210 from the flash memory device 120 to the disk drive 210 (S28).

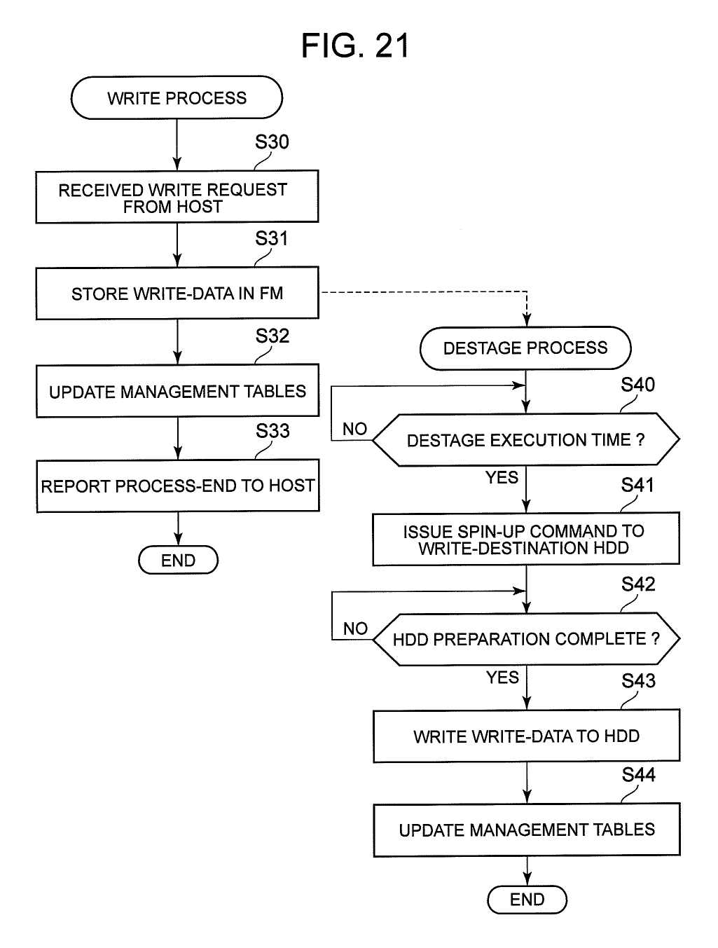

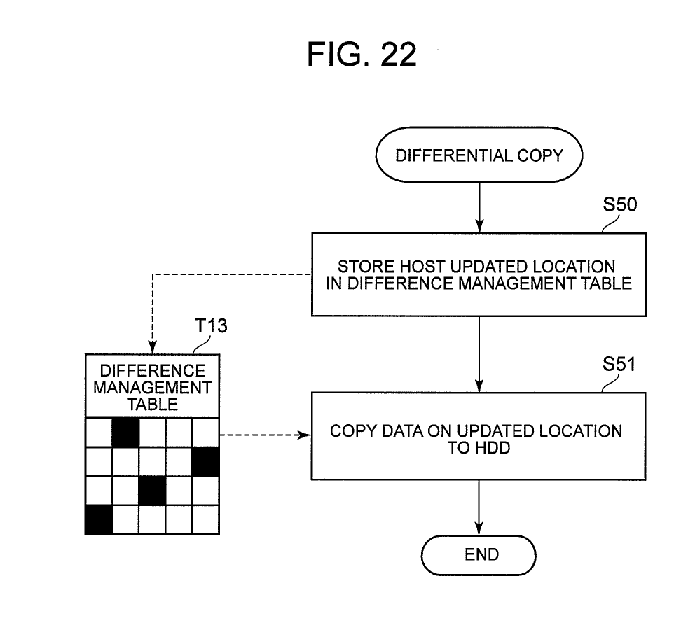

FIG. 21 is a flowchart for processing a write request from the host 20. The storage controller 10, upon receiving a write request (S30), stores the write-data received from the host 20 in the flash memory device 120 (S31). Then, the storage controller 10 updates the required management table, such as a difference management table T13 (refer to FIG. 22) (S32), and notifies process-end to the host 20 (S33).

Meanwhile, the storage controller 10 determines whether or not the time for executing a destage process has arrived (S40). The destage process execution time is selected based on the nighttime time zone, when the power rate is low, as described hereinabove.

When the destage process execution time has arrived (S40: YES), the storage controller 10 issues a spin-up command to the storage-destination disk drive 210, boots up the disk drive 210 (S41), and determines whether or not preparations for the write-targeted disk drive 210 have been completed (S42).

When the write-targeted disk drive 210 preparations have been completed (S42: YES), the storage controller 10 transfers the data stored in the flash memory device 120 and stores this data in the write-targeted disk drive 210 (S43). The storage controller 10 updates the required management table, such as the difference management table T13 (S44), and ends the destage process.

FIG. 22 is a flowchart showing the process for carrying out a differential-copy. The storage controller 10 records the location updated by the host 20 (that is, the updated logical block address) in the difference management table T13 (S50). The difference management table T13 manages a location in which data has been updated in a prescribed unit. The difference management table T13 can be configured as a difference bitmap.

Then, the storage controller 10 copies only the data in the location updated by the host 20 to the disk drive 210 by referencing the difference management table T13 (S51). Consequently, the storage content of the flash memory device 120 and the storage content of the disk drive 210 can be made to coincide in a relatively short time.

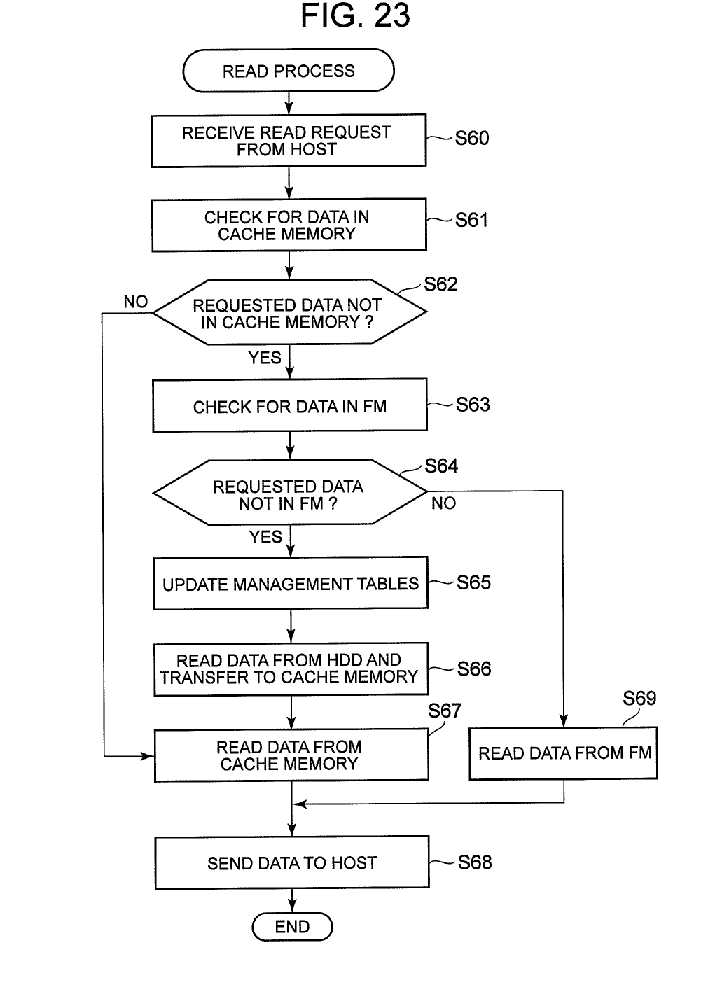

FIG. 23 is a flowchart for processing a read request from the host 20. The storage controller 10, upon receiving a read request issued from the host 20 (S60), checks the data stored in the cache memory 150 (S61).

When the data, for which a read was requested from the host 20, is not stored in the cache memory 150 (S62: YES), the storage controller 10 checks the data stored in the flash memory device 120 (S63).

When the data for which the read was requested is not stored in the flash memory device 120 (S64: YES), the storage controller 10 updates the required management table, such as the device status management table T3 (S65), reads out the read-targeted data from the disk drive 210, and transfers this data to the cache memory 150 (S66). The storage controller 10 reads out the read-targeted data from the cache memory 150 (S67), and sends this data to the host 20 (S68).

When the read-targeted data is stored in the cache memory 150 (S62: NO), the storage controller 10 sends the data stored in the cache memory 150 to the host 20 (S67, S68).

When the read-targeted data is stored in the flash memory device 120 (S64: NO), the storage controller 10 reads out the data from the flash memory device 120 (S69), and sends this data to the host 20 (S68).

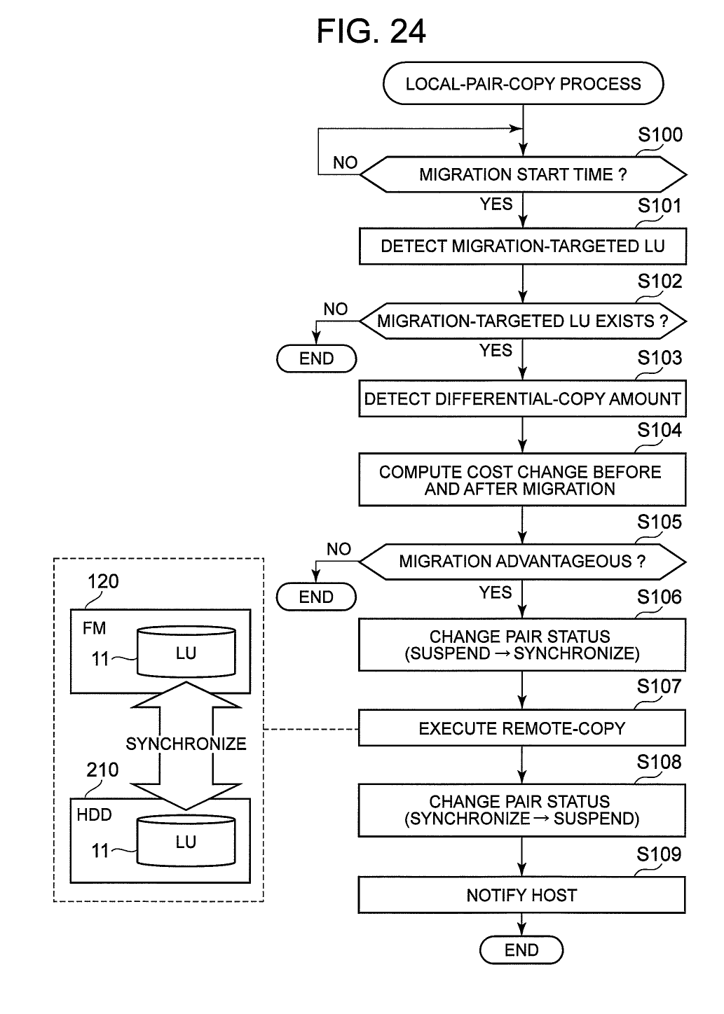

FIG. 24 is a flowchart showing the process for migrating data between the flash memory device 120 and the disk drive 210 inside the same storage controller 10. FIGS. 20 and 21, for example, showed cases in which data is migrated between the flash memory device 120 and the disk drive 210 in segment units or page units.

By contrast, in FIG. 24, a case in which data is migrated in volume units will be explained. Logical volumes 11 are respectively provided in the flash memory device 120 and the disk drive 210. A local copy-pair can be configured in accordance with the logical volume 11 based in the flash memory device 120 and the logical volume 11 based in the disk drive 210.

The storage controller 10, for example, determines whether or not data migration time has arrived based on the power rate switching time (S100). When the migration time as arrived (S100: YES), the storage controller 10 searches for a migration-targeted volume (S101), and determines whether or not a migration-targeted volume exists (S102).

When a migration-targeted volume does not exist (S102: NO), this processing ends. When a migration-targeted volume exists (S102: YES), the storage controller 10 detects the amount of difference data between the migration-targeted volume (migration-source volume) and the migration-destination volume (S103), and computes the change in power costs before and after the migration (S104). The time required for migrating the difference data can be computed from the amount of difference data and the line speed. The migration end-time can be estimated based on the prescribed migration time. The cost of power required for migration, the power cost when migration is carried out, and the power cost when migration is not carried out can be respectively estimated based on the migration end-time and the power rate.

The storage controller 10 determines whether or not there is a power cost advantage to migrating data between the flash memory device 120 and the disk drive 210 (S105). For example, when a long time is required for data migration, and the data cannot be migrated only at night, when the power rate is low, the disk drive 210 will also be operated in the daytime, when the power rate is high. If the high-power-consumption disk drive 210 is operated for a long period of time in a high-power-rate time zone, the cost of power will increase.

When it is determined that there is no advantage to data migration from the standpoint of power costs (S105: NO), this processing ends. When it is determined that there is a power cost advantage (S105: YES), the storage controller 10 changes the pair status of the copy-pair configured by the logical volume 11 based on the flash memory device 120 and the logical volume 11 based on the disk drive 210 from the suspend status to the synchronize status (S106). In accordance with the pair status being changed to synchronize status, difference data is remote copied between the logical volume 11 based on the flash memory device 120 and the logical volume 11 based on the disk drive 210 (S107).

When inter-volume synchronization has ended, the storage controller 10 changes the pair status from the synchronize status to the suspend status (S108), and notifies the host 20 (S109).

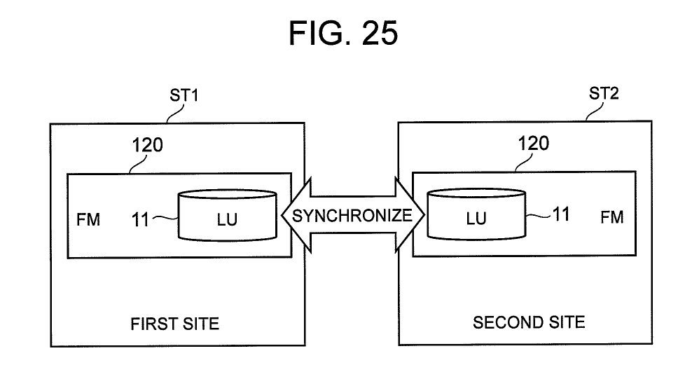

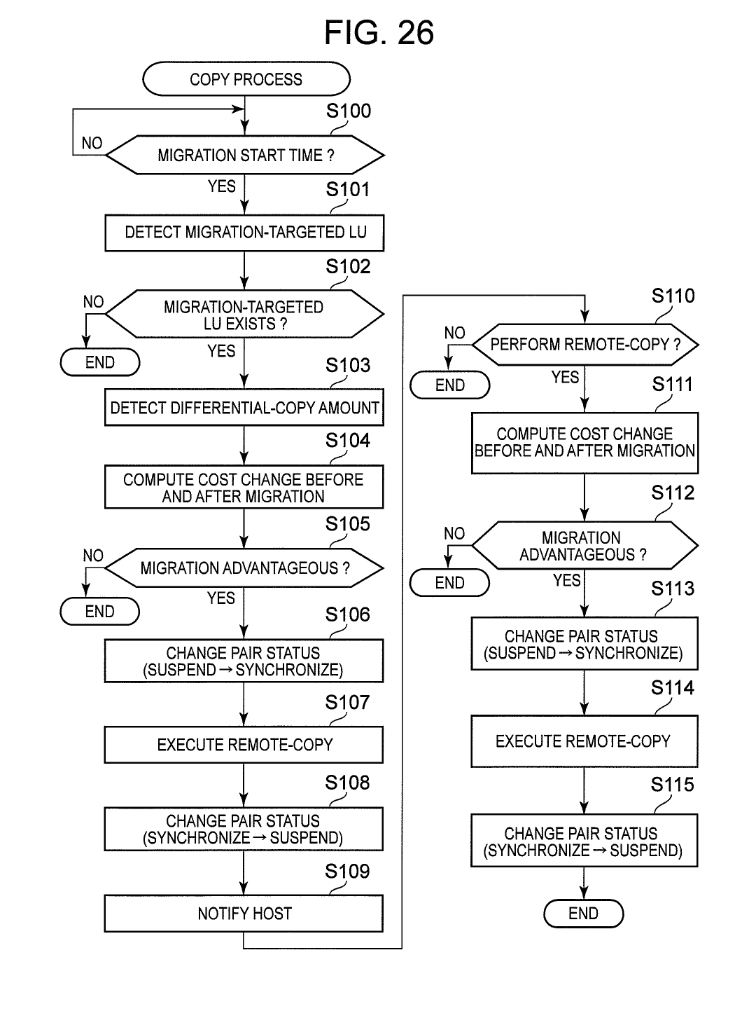

The method for migrating data in volume units between a plurality of different sites will be explained on the basis of FIGS. 25 and 26. FIG. 25 is a diagram schematically showing how data is migrated between sites.

As shown in FIG. 25, in this embodiment, data can be migrated from the flash memory device 120 of the first site ST1 to the flash memory device 120 of the second site ST2. Furthermore, data can also be migrated from the flash memory device 120 of the first site ST1 to the disk drive 210 of the second site ST2.

FIG. 26 is a flowchart showing a copy process. The flowchart shown in FIG. 26 comprises all the steps S100 through S109 in the flowchart shown in FIG. 24. In FIG. 26, S110 through S115 are added anew. Accordingly, the explanation will focus on the newly added steps in FIG. 26. In the explanation of this process, (ST1) will be appended to the reference numerals of the respective elements located inside the first site ST1, and (ST2) will be appended to the reference numerals of the respective elements located inside the second site ST2.

When data migration from the flash memory device 120 (ST1) inside the storage controller 10 (ST1) to the disk drive 210 (ST2) has been completed (S109), the storage controller 10 (ST1) determines whether or not to implement a remote-copy to the second site ST2 (S110).

When a remote-copy is not configured for the logical volume 11 inside the flash memory device 120 (ST1) (S110: NO), this processing ends. When a remote-copy is configured (S110: YES), the storage controller 10 (ST1) determines whether or not there is a power cost advantage to copying data to the second site ST2 (S112). When it is determined that there is no advantage (S112: NO), this processing ends.

When it is determined that there is an advantage from the standpoint of power costs (S112: YES), the storage controller 10 (ST1) changes the status of the remote-copy-pair configured by the remote-copy-source volume and the remote-copy-destination volume from the suspend status to the synchronize status (S113). In this example, as shown in FIG. 25, the remote-copy-source logical volume 11 (ST1) resides in the flash memory device 120 (ST1) of the first site ST1, and the remote-copy-destination logical volume 11 (ST2) resides in the flash memory device 120 (ST2) of the second site ST2.

By configuring the pair status of the logical volume 11 (ST1) and the logical volume 11 (ST2) to the synchronize status (S113), the difference data is remote copied from the logical volume 11 (ST1) to the logical volume 11 (ST2) (S114). When the remote-copy ends, the storage controller 10 (ST1) changes the pair status from the synchronize status to the suspend status (S115).

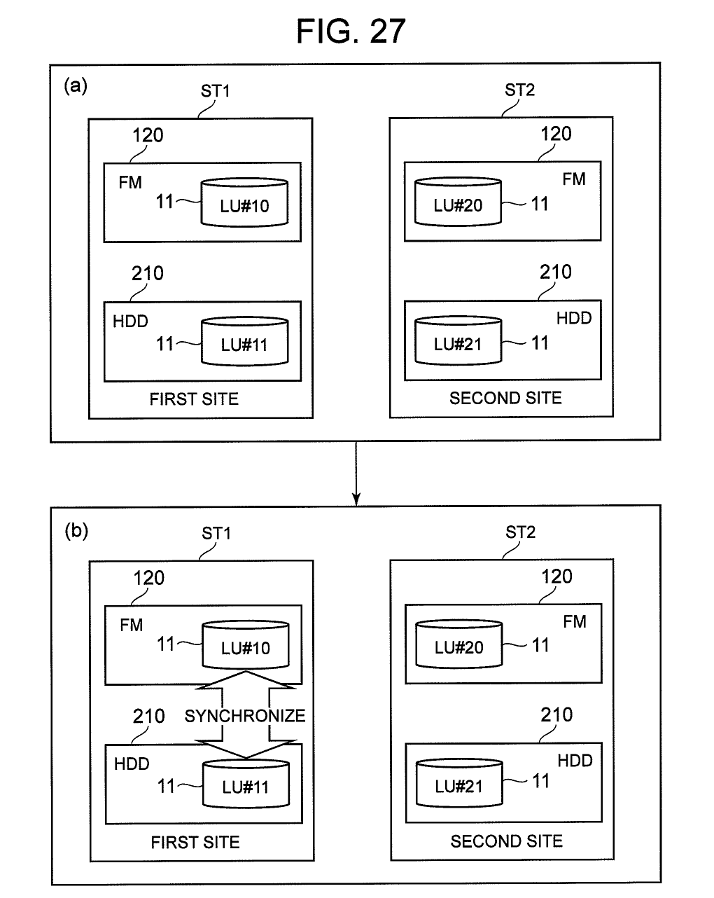

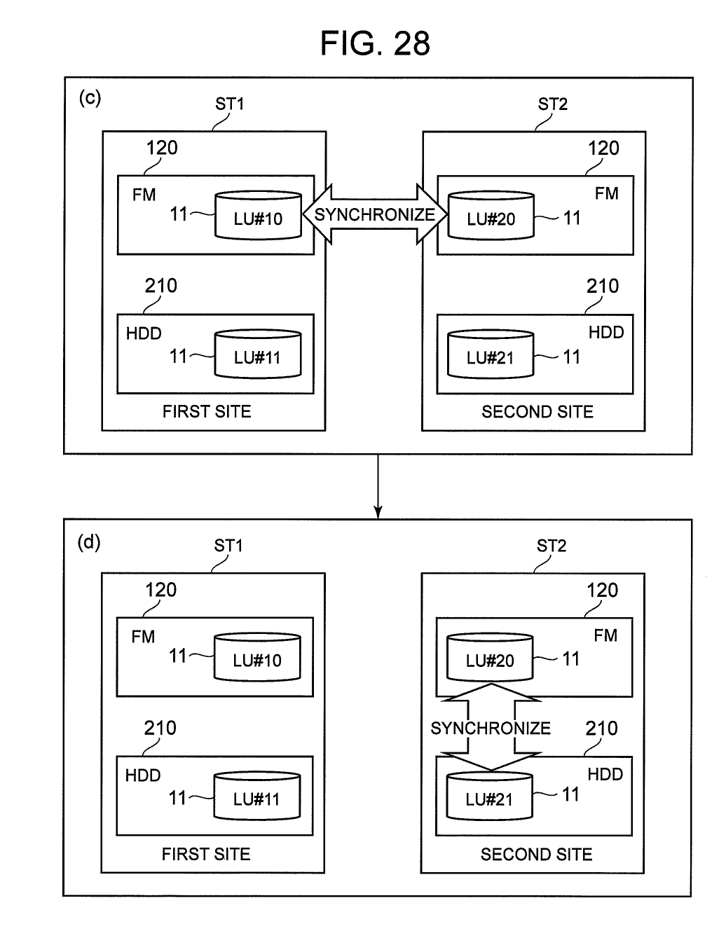

FIGS. 27 and 28 are diagrams schematically showing how data migration is carried out by the storage system of this embodiment. FIG. 27A shows initialization. FIG. 27B shows how a local-copy is executed between the flash memory device 120 (ST1) and disk device 210 (ST1). Consequently, at least a portion of the prescribed data stored in the volume 11 (#11) inside the disk drive 210 (ST1) is stored in the volume 11 (#10) inside the flash memory device 120 (ST1).

FIG. 28C shows how a remote-copy is carried out. A remote-copy-pair is created by the volume 11 (#10) inside the flash memory device 120 (ST1) and the volume 11 (#20) inside the flash memory device 120 (ST2), and the difference data between volume 11 (#10) and volume 11 (#20) is sent from volume 11 (#10) to volume 11 (#20).

FIG. 28D shows how a local-copy is carried out in the second site ST2. The data of volume 11 (#20) is differentially copied to the volume 11 (#21) inside the disk drive 210 (ST2). Therefore, a copy of the original data is stored inside the second site ST2 as well. If the remote-copy-destination site shown in FIG. 28C is selected from sites in regions where the power rates are low, and a local-copy process is executed in the remote-copy-destination site in a low-power-rate time zone, an increase in the cost of power for the storage system as a whole can be prevented, and disaster recovery performance can be heightened.

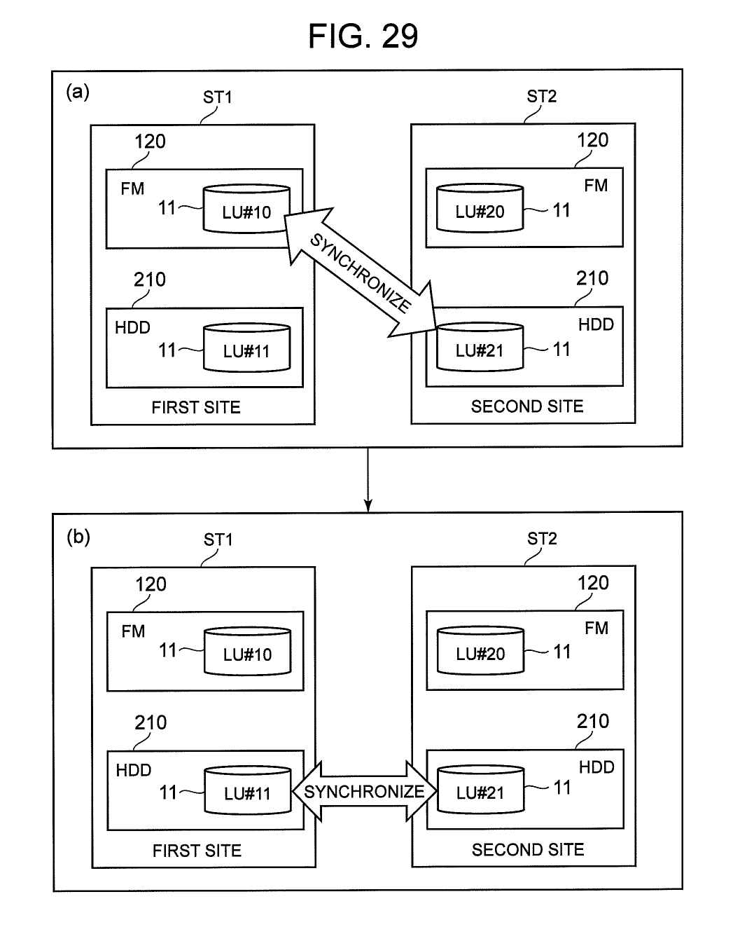

FIG. 29 is a diagram showing another example of data migration by the storage system. As shown in FIG. 29A, data can also be copied directly from the flash memory device 120 (ST1) of the first site ST1 to the disk drive 210 (ST2) of the second site ST2 without passing through the flash memory device 120 (ST2) of the second site ST2.

As shown in FIG. 29B, a remote-copy-pair can also be created with the volume (#11) inside the disk drive 210 (ST1) of the first site ST1 and the volume (#21) inside the disk drive 210 (ST2) of the second site ST2.

Comprising the constitution described hereinabove, this embodiment achieves the following effects. This embodiment controls the data storage destination taking into account not only the power consumption difference between the flash memory device 120 and the disk drive 210, but also the power rate difference resulting from the time zone, and the power rate difference of the respective regions.

Therefore, the high-power-consumption disk drive 210 can be run during the night when the power rate is low to copy the prescribed data to the flash memory device 120 in advance. The low-power-consumption flash memory device 120 can be used in the daytime, when the power rate is high, to process access requests from the host 20. As a result, the power consumption of the storage controller 10 can be reduced.

Furthermore, this embodiment can make use of regional power rate differences to store a copy of the data in a site provided in a region where the power rate is low. Therefore, a data backup or the like can be implemented without increasing the power costs of the storage system.

In this embodiment, since the constitution is such that write-data received from the host 20 is stored directly in the flash memory device 120 without going through the cache memory 150, cache memory 150 utilization can be reduced, and the time required to store the write-data can also be shortened.

### Embodiment 2

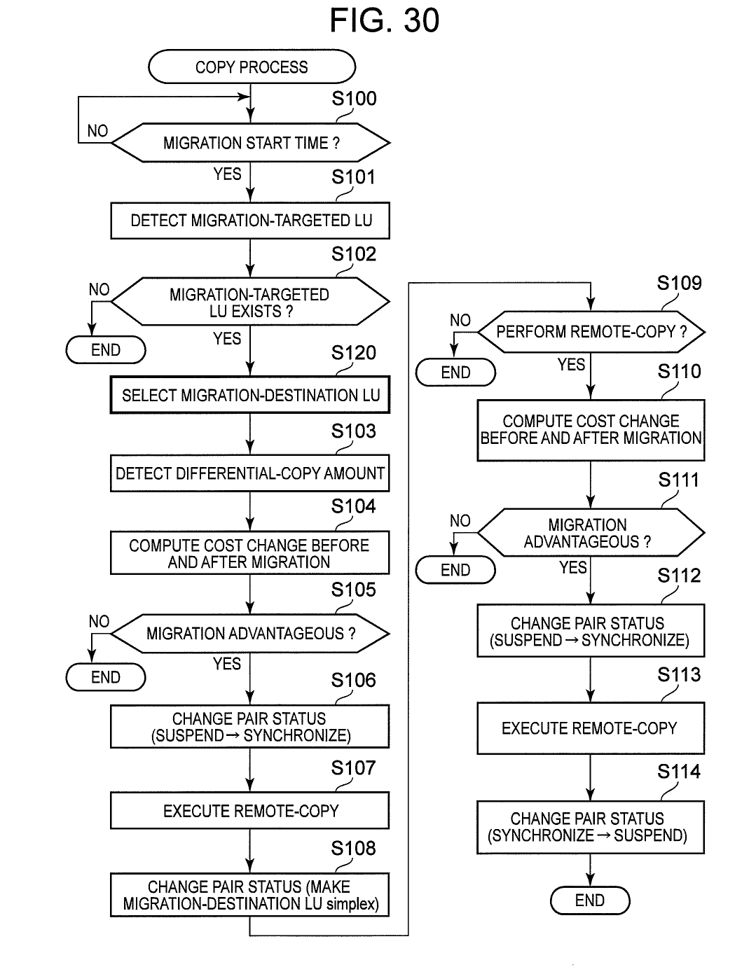

A second embodiment will be explained on the basis of FIGS. 30 through 32. The respective embodiments described hereinbelow correspond to variations of the first embodiment. Hereinafter, explanations of the parts that are shared in common with the first embodiment will be omitted, and the explanations will focus on the parts that are characteristic of the respective embodiments.

In this embodiment, when there are a plurality of logical volumes 11 based on the flash memory device 120 and a plurality of logical volumes 11 based on the disk drive 210, a local-copy-pair is configured in accordance with the status rather than configuring a local-copy-pair in advance.

FIG. 30 is a flowchart of a copy process according to this embodiment. This process comprises all the steps S100 through S115 of the flowchart shown in FIG. 26, and also adds step S120 anew. Furthermore, in S108 of this embodiment, when inter-volume synchronization is complete, the status of the copy-destination volume changes to stand-alone operation (simplex).

In this embodiment, when a local-copy is carried out between the flash memory device 120 and disk drive 210 inside the same storage controller 10 (S102: YES), the storage controller 10 selects the migration-destination volume (S120). The migration-destination volume is the copy-destination volume of the local-copy.

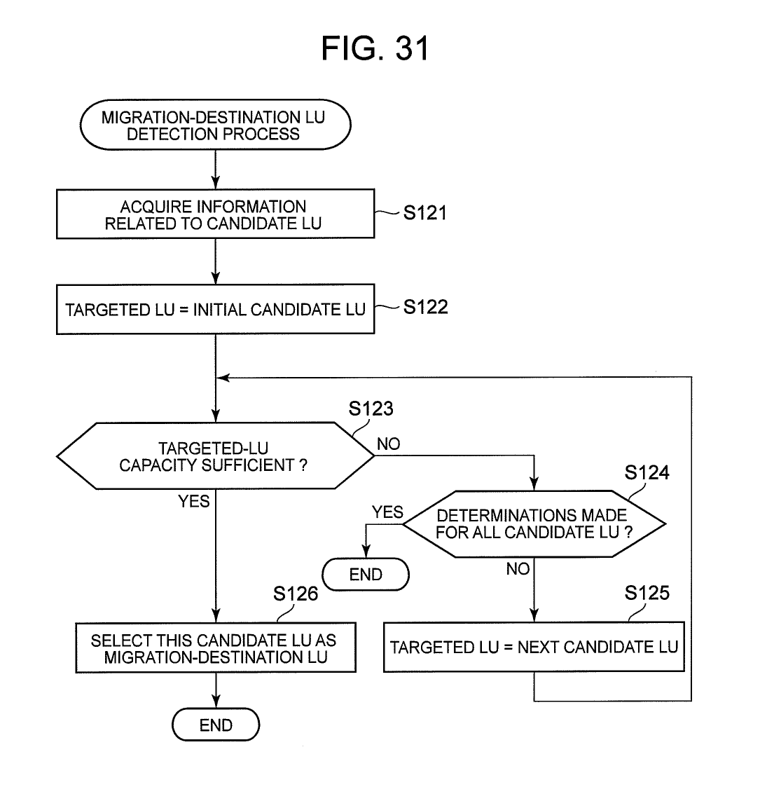

FIG. 31 is a flowchart showing the process for selecting the migration-destination volume. The storage controller 10 respectively acquires information on the volumes, which constitute migration-destination volume candidates (S121), and sets the first candidate volume number in the determination-target volume number (S122).

The storage controller 10 compares the capacity of the candidate volume against the capacity of the migration-source volume, and determines whether or not the candidate volume capacity is sufficient (S123). When the candidate volume capacity is less than the capacity of the migration-source volume (S123: NO), the storage controller 10 determines whether or not determinations have been made for all the candidate volumes (S124). When there is a candidate volume for which a determination has yet to be made (S124: NO), the storage controller 10 sets the number of the next candidate volume in the determination-target volume number (S125), and returns to S123.

When the candidate volume capacity is either equivalent to or greater than the capacity of the migration-source volume (S123: YES), the storage controller 10 selects this candidate volume as the migration-destination volume (S126).

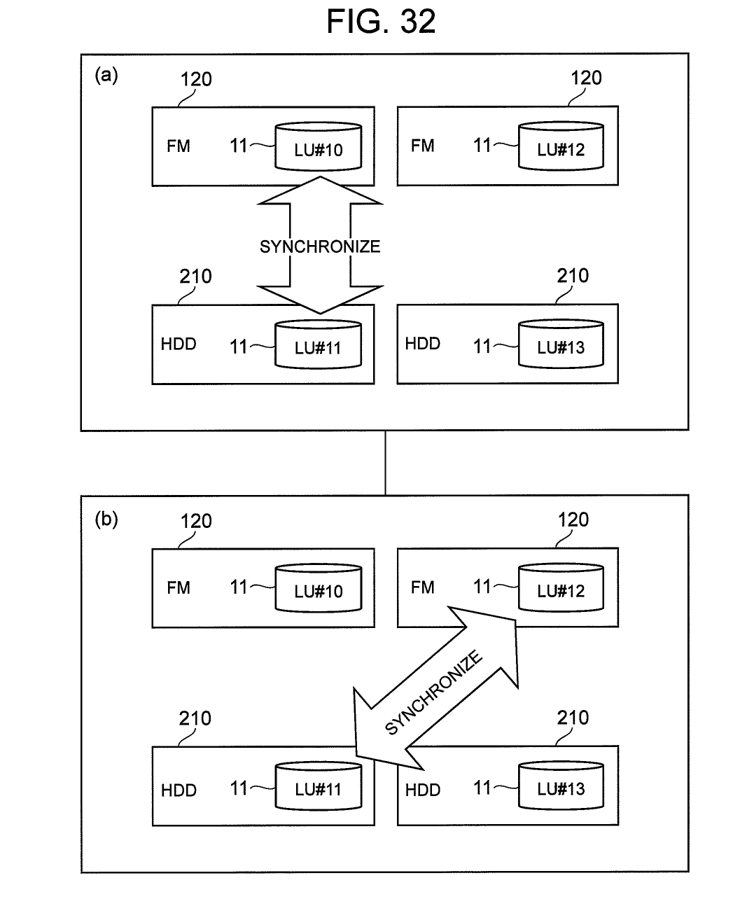

FIG. 32 is a diagram showing how the migration-destination volume is selected. It is supposed that the migration-source volume is volume 11 (#11). When a plurality of volumes 11 (#10), 11 (#12) is configured in the flash memory device 120, the storage controller 10 selects any one of the volumes as the migration-destination volume. FIG. 32A shows that volume 11 (#10) has been selected, and FIG. 32B shows that the other volume 11 (#12) has been selected.

Constituting this embodiment like this achieves the same effects as the first embodiment. Furthermore, in this embodiment, for example, when there is a plurality of volumes 11 (#10, #12) capable of being selected as the staging destination, the data can be migrated by selecting a suitable volume 11 from thereamong.

### Embodiment 3

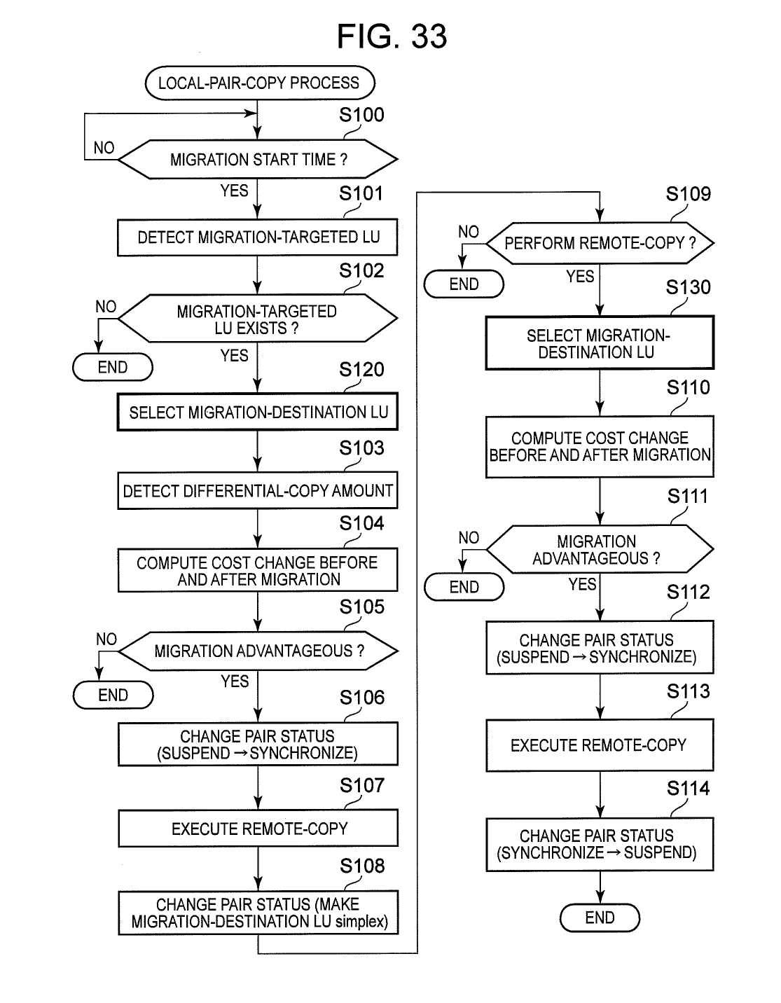

A third embodiment will be explained on the basis of FIGS. 33 through 36. In this embodiment, a remote-copy-destination volume is not configured beforehand, but rather a remote-copy-destination volume is selected when a remote-copy is executed. Hereinafter, a case in which this process is executed by a storage controller 10 having a remote-copy-source volume will be explained. Beside this, the constitution can also be such that the management server 30 executes this process, and configures the copy method in the storage controller 10, which implements the local-copy and remote-copy.

FIG. 33 is a flowchart of a copy process according to this embodiment. This flowchart comprises all the steps S100 through S114, and S120 shown in FIG. 30, plus a new step S130 is also added. In this embodiment, when the storage controller 10 decides to implement a remote-copy (S109: YES), the storage controller 10 selects a remote-copy-destination volume (S130). In this embodiment, only the fact that a remote-copy will be carried out is configured in the schedule management table T6; volume to which the remote-copy is to be made to is not configured.

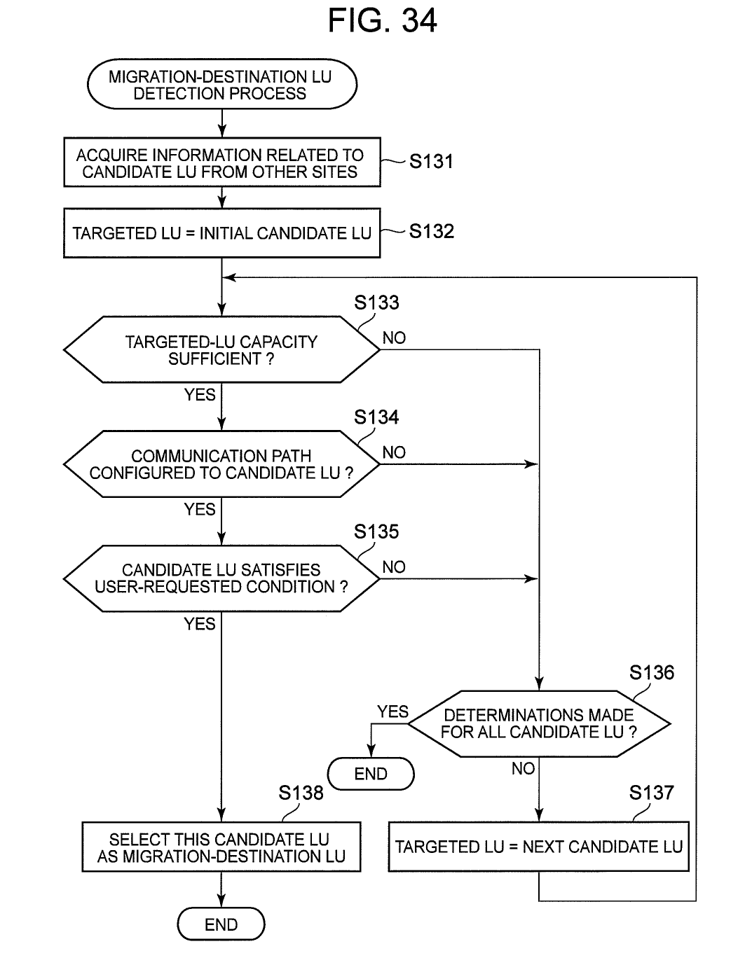

FIG. 34 shows the process for selecting a remote-copy-destination volume. The storage controller 10 respectively acquires information on the volumes 11, which constitute remote-copy-destination volume candidates (S131).

The storage controller 10 sets the first candidate volume number in the determination-target volume number (S132). The storage controller 10 determines whether or not the capacity of this candidate volume is sufficient (S133).

That is, the storage controller 10 compares the capacity of the candidate volume against the capacity of the remote-copy-source volume, and determines whether or not the candidate volume capacity is greater than the capacity of the remote-copy-source volume (S133). When the candidate volume capacity is insufficient (S133: NO), the storage controller 10 moves to S136.

When the candidate volume capacity is sufficient (S133: YES), the storage controller 10 determines whether or not a communication channel for carrying out a remote-copy is configured between the remote-copy-source volume and the candidate volume (S134). When a communication channel for a remote-copy has not been configured (S134: NO), the storage controller 10 moves to S136.

When a communication channel for carrying out a remote-copy has been configured between the remote-copy-source volume and the candidate volume (S134: YES), the storage controller 10 determines whether or not this candidate volume satisfies a user-requested condition (for example, minimum response time) (S135). When the candidate volume does not satisfy the user-requested condition (S135: NO), the storage controller 10 proceeds to S136.

When the candidate volume satisfies the user-requested condition (S135: YES), the storage controller 10 selects this candidate volume as the remote-copy-destination volume (S138).

When NO is determined for any of S133, S134, or S135, the storage controller 10 determines whether or not determinations have been made for all the candidate volumes (S136). When undetermined candidate volumes remain (S136: NO), the storage controller 10 sets the next candidate volume number in the determination-target volume number (S137), and returns to S133.

Furthermore, the constitution can be such that when a communication channel for a remote-copy has not been configured (S134: NO), information to this effect is notified to the user. This is because the user can configure a communication channel for a remote-copy based on the notified contents. Furthermore, the constitution can also be such that when the candidate volume does not satisfy the user-requested condition (S135: NO), information to this effect is notified to the user. The user, who receives the notification, can consider relaxing the requested condition.

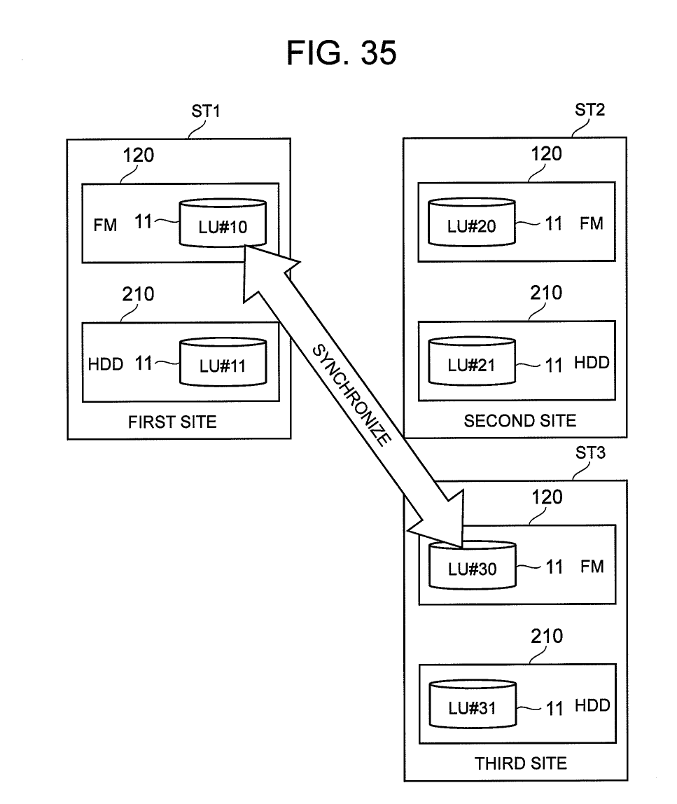

FIG. 35 is a diagram schematically showing a remote-copy according to this embodiment. When there is a plurality of remote-copy-destination candidate sites ST2, ST3, the storage controller 10 of the first site ST1 selects either one of the sites ST2, ST3. In the example of FIG. 35, the volume 11 (#30) provided in the flash memory device 120 inside the third site ST3 is selected as the remote-copy-destination volume.

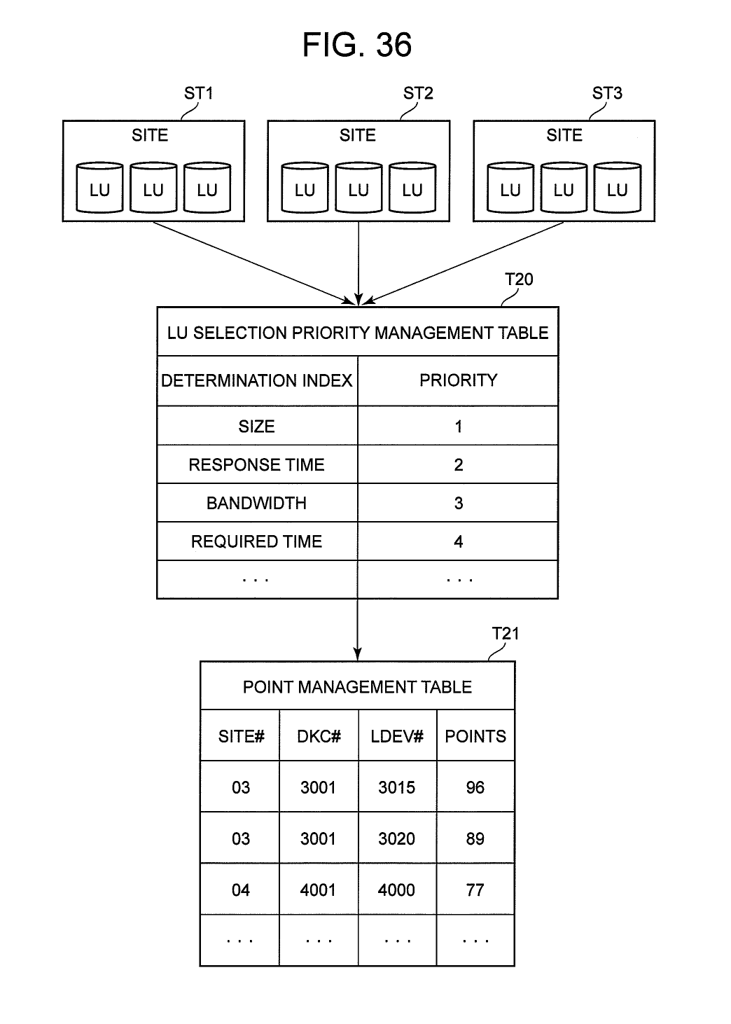

As shown in FIG. 36, the constitution can also be such that priorities are configured for a plurality of determination indices, and a volume from inside the storage system is selected as a remote-copy-destination volume.

A volume selection priorities management table T20 is a table for managing the priorities of a plurality of indices taking into account the selection of a remote-copy-destination volume. The determination indices, for example, can include volume capacity (first); response time (second); communication bandwidth (third); and time required for a remote-copy (fourth). A priority is configured in advance for each determination index. In the examples given in FIG. 36, the lower the numeral, the higher the priority.

A point managing table T21 is for tabulating the total points that the respective candidate volumes acquire based on the respective determination indices. The storage controller 10 can select the candidate volume having the highest number of points as the remote-copy-destination volume.

In the example given in FIG. 36, whether a remote-copy communication channel has been configured or not is not particularly problematic. This is because a remote-copy communication channel can be configured as needed. However, the existence of a remote-copy communication channel can be added as one of the determination indices.

Constituting this embodiment like this achieves the same effects as the first and second embodiments. Furthermore, in this embodiment, usability is enhanced since a remote-copy-destination volume is automatically selected in accordance with the current situation in the storage system. Furthermore, the constitution can be such that the process for selecting a remote-copy-destination volume (S130) is executed in advance in the midst of executing a local-copy (S100 through S108).

### Embodiment 4

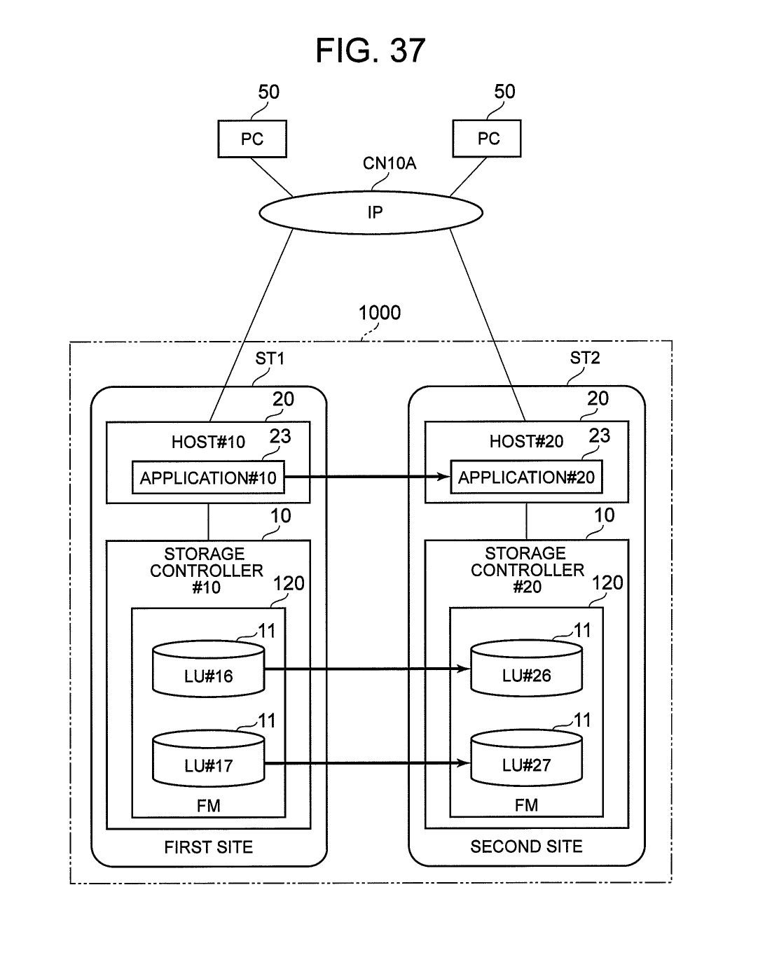

A fourth embodiment will be explained on the basis of FIGS. 37 through 40. In this embodiment, an application program execution-destination is shifted between hosts 20 in accordance with the migration of data (a remote-copy) between storage controllers 10.

FIG. 37 schematically shows the constitution of the entire storage system according to this embodiment. The application program 23 (#10) of the first site ST1 uses volumes 11 (#16) and 11 (#17) inside the first site ST1 to provide a job processing service to the user terminal 50.

In the one volume 11 (#16), for example, there is stored a program and data used in the job processing service, and in the other volume 11 (#17), for example, there is stored data related to the job processing service, such as a list of clients' names and so forth.

In an attempt to further reduce power costs, volume data is migrated from the first site ST1 to the second site ST2. The data of the one volume 11 (#16) is remote copied to the one remote-copy-destination volume 11 (#26), and the data of the other volume 11 (#17) is remote copied to the other remote-copy-destination volume 11 (#27).

The provision-source of the job processing service is also shifted from the first site ST1 to the second site ST2 in accordance with the migration of the volume via the remote-copy. The migration-source host 20 (#10) suspends the application program 23 (#10), and the migration-destination host 20 (#20) boots up the application program 23 (#20).

The job processing service provided by the first site ST1 and the job processing service provided by the second site ST2 constitute a cluster 1000. That is, in this embodiment, job processing services are clustered so as to span a plurality of sites.

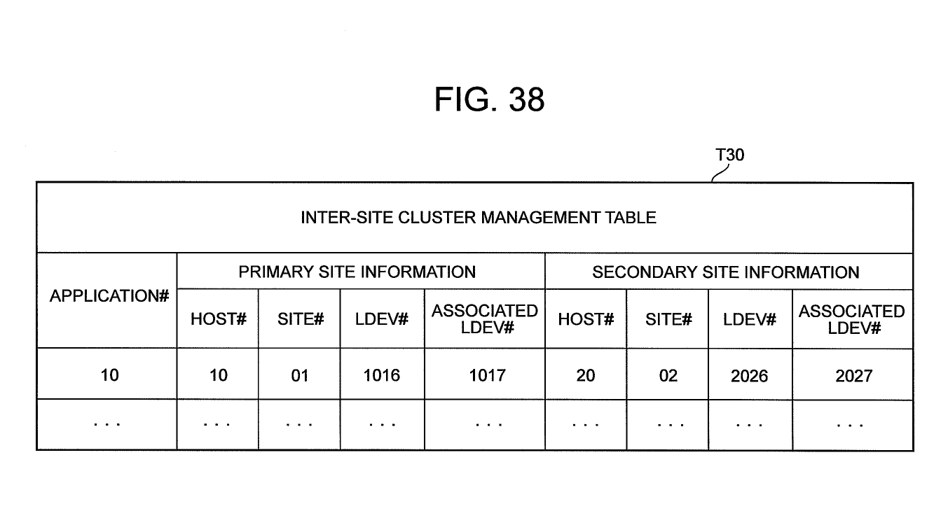

FIG. 38 is a diagram showing a table for managing the cluster 1000 configured from the plurality of sites. An inter-site cluster management table T30, for example, comprises an application number; primary site information; and secondary site information. Primary site information comprises a primary host number; a primary site number; a primary volume number; and a primary association volume number. Similarly, secondary site information comprises a secondary host number; a secondary site number; a secondary volume number; and a secondary association volume number.

The application number is information for identifying a migration-targeted application program 23. The primary host number is information for identifying the host 20 on which the application program 23, which provides the job processing service, is running. The primary site number is information for identifying the site, which has the primary host 20. The primary volume number is information for identifying the volume primarily used by the application program 23. The primary association volume number is information for identifying the volume storing data associated to the primary volume. Explanations of the secondary site information will be omitted.

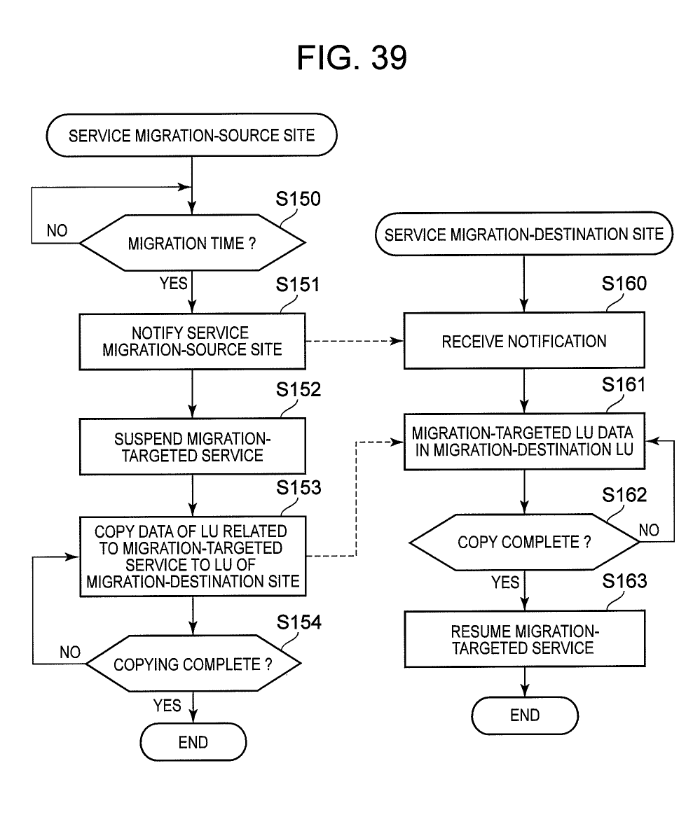

FIG. 39 is a flowchart showing the process for migrating a job processing service. The storage controller 10 of the service-migration-source site (hereinafter, migration-source storage controller 10 (ST1)) determines whether or not migration time has arrived based on the schedule (S150). That is, a determination is made as to whether or not the provision-source of the job processing service should be moved to the migration-destination site in order to reduce the power costs of the storage system as a whole (S150).

When the migration time has arrived (S150: YES), the migration-source storage controller 10 (ST1) notifies the storage controller 10 of the service-migration-destination site (hereinafter, the migration-destination storage controller 10 (ST2)) of the start of the migration process (S151).

The migration-source storage controller 10 (ST1) suspends the migration-targeted application program 23 (S152). Next, the migration-source storage controller 10 (ST1) respectively remote copies the data of the volumes 11 (#16, #17) used by the migration-targeted application program 23 to the volumes 11 (#26, #27) of the migration-destination site ST2 (S153).

The inter-volume data migration is as described hereinabove, and as such, a detailed explanation thereof will be omitted. The data can be migrated by configuring the pair status of the remote-copy-source volume and the remote-copy-destination volume to the synchronize status.

When the remote-copy from the remote-copy-source volumes 11 (#16, #17) to the remote-copy-destination volumes (#26, #27) is complete (S154: YES), the status of the remote-copy-pair returns to the suspend status, and the processing at the migration-source site ends.

The migration-destination storage controller 10 (ST2) receives a migration-start notification (S160), and stores the data sent from the migration-source storage controller 10 (ST1) in the migration-destination volumes 11 (#26, #27) (S161).

When the remote-copy is complete (S162: YES), the migration-destination storage controller 10 (ST2) boots up the application program 23 (#20) in the host 20 of the migration-destination site ST2, and resumes providing the job processing service (S163).

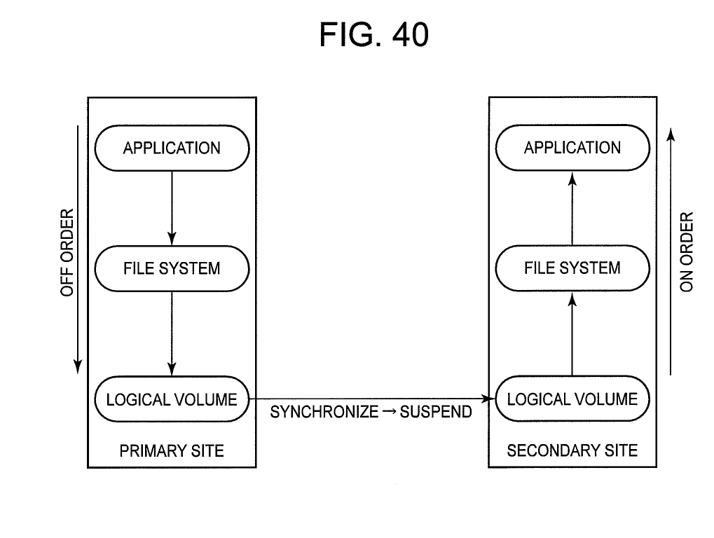

FIG. 40 schematically shows the processing order. As shown in the left side of the figure, the use of the application program, file system and volume is suspended in that order in the migration-source site. As shown in the right side of the figure, the volume, file system, and application are operated in that order in the migration-destination site.

Constituting this embodiment like this achieves the same effects as the first embodiment. Furthermore, this embodiment makes good use of differences in power rates by time and region to move data to the site with the lowest power costs, and to provide a job processing service at the site with the lowest power costs. Therefore, the power costs of the storage system as a whole can be reduced.

### Embodiment 5

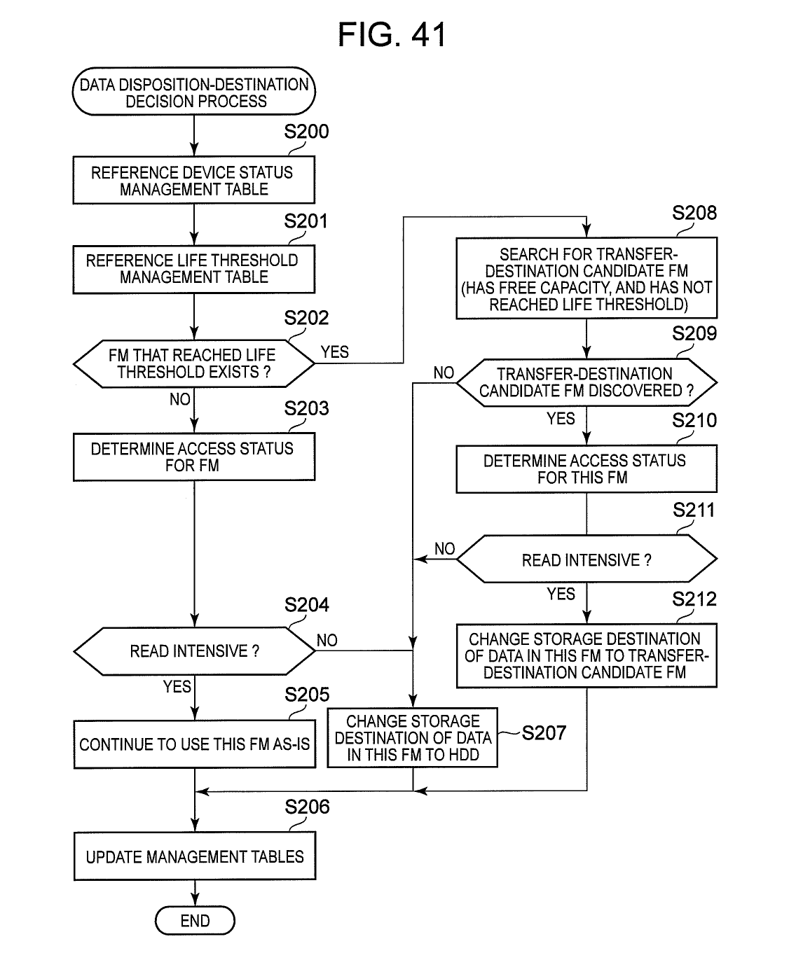

A fifth embodiment will be explained on the basis of FIG. 41. FIG. 41 is a flowchart showing the process for deciding a data disposition destination. This process is executed for automatically configuring the “disposition-destination fixing flag” in the schedule management table T6.

That is, in the following process, a decision is made as to the propriety of a staging process from the disk drive 210 to the flash memory device 120 based on the reliability of the flash memory device 120 (remaining life) and the data access pattern, and the result of this decision is recorded in the schedule management table T6.

The storage controller 10 references the device status management table T3 (S200), and also references the life threshold management table T4 (S201). The storage controller 10 determines whether or not there is a flash memory device 120 for which the life threshold has been reached for any one of the life estimation parameters (S202).

When none of the flash memory devices 120 has reached the life threshold (S202: NO), the storage controller 10 determines the access status related to the flash memory device 120 (S203). The storage controller 10 determines whether or not accesses related to this flash memory device 120 are read-access-intensive (S204). The storage controller 10, for example, can determine whether or not accesses are read-intensive from the percentages of the total number of read accesses and the total number of write accesses relative to this flash memory device 120. For example, when read accesses are n-times (n is a natural number) greater than write accesses, a determination can be made that the flash memory device is used primarily for read access.

When access is read-intensive (S204: YES), the storage controller 10 decides that this flash memory device 120 will continue to be used as-is (S205), and, if necessary, updates the schedule management table T6 (S206). However, when the continued use of the flash memory device 120 has been decided (S205), there is no need to update the schedule management table T6.

By contrast, when access to the flash memory device 120 is not read-intensive, but rather there are a relatively large number of write accesses (S204: NO), the storage controller 10 changes the storage location of the data stored in this flash memory device 120 to the disk drive 210 (S207). That is, since the life of the flash memory device 120 will be shortened the larger the number of write accesses there are, the storage controller 10 affixes the data storage location in advance to the disk drive 210 (S207). The storage controller 10 configures the device number of the disk drive 210 in the disposition-destination fixing flag of this data (S206).

When there is a flash memory device 120 for which any of the life estimation parameters has reached the life threshold (S202: YES), the storage controller 10 searches for another flash memory device 120 in order to change the data storage destination (S208). That is, the storage controller 10 detects a flash memory device 120, which has free capacity and sufficient life remaining, as a candidate for the data transfer destination (S208).

When a transfer-destination candidate flash memory device 120 is detected (S209: YES), the storage controller 10 determines the access status for this transfer-destination candidate flash memory device 120 (S210), and determines whether or not accesses to this transfer-destination candidate flash memory device 120 are read-intensive (S211).

When the accesses to the transfer-destination candidate flash memory device 120 are read-intensive (S211: YES), the storage controller 10 selects this transfer-destination candidate flash memory device 120 as the data storage destination in place of the flash memory device 120 with little life left (S212). In this case, the storage controller 10 records the device number of the selected flash memory device 120 in the schedule management table T6 as the new storage destination (S206).

By contrast, when not one transfer-destination candidate flash memory device 120 can be detected (S209: NO), or when the transfer-destination candidate flash memory device 120 is not read-intensive (S211: NO), the storage controller 10 changes the data storage destination to the disk drive 210 (S207).

Constituting this embodiment like this achieves the same effects as the first embodiment. Furthermore, this embodiment controls the data disposition destination by taking into account the technological nature of the flash memory device, the life of which is degraded by writes. Therefore, it is possible to prevent the deterioration of flash memory device life while lowering power costs.

### Embodiment 6

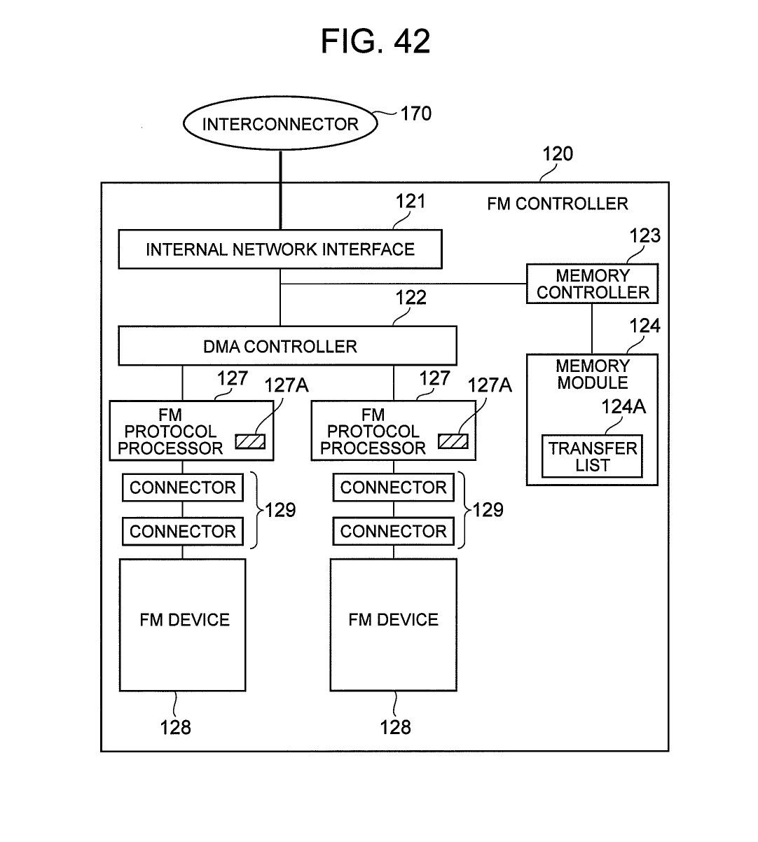

A sixth embodiment will be explained on the basis of FIG. 42. In this embodiment, a variation of the FM controller 120 will be explained. FIG. 42 is a diagram showing the constitution of an FM controller 120 according to this embodiment. The FM controller 120 of this embodiment comprises an FM protocol processor 127 instead of the memory controller 125 of the first embodiment. Further, the FM controller 120 of this embodiment has a flash memory device 128 instead of a flash memory 126.

The FM protocol processor 127 is for carrying out data communications with the flash memory device 128. Furthermore, the memory 127A built into the FM protocol processor 127 can record historic information related to accesses to the flash memory device 128.

The FM protocol processor 127 is connected to the flash memory device 128 by way of a connector 129. Therefore, the flash memory device 128 is detachably attached to the FM controller 120.

The first embodiment presented a constitution, which provided a flash memory 126 on the circuit board of the FM controller 120. Therefore, in the above-mentioned embodiment, increasing the capacity of the flash memory, and replacing a failed flash memory are troublesome tasks. By contrast, in this embodiment, the flash memory device 128 is detachably attached to the FM protocol processor 127 via the connector 129, enabling the flash memory device 128 to be easily replaced with a new flash memory device 128 or a large-capacity flash memory device 128.

### Embodiment 7

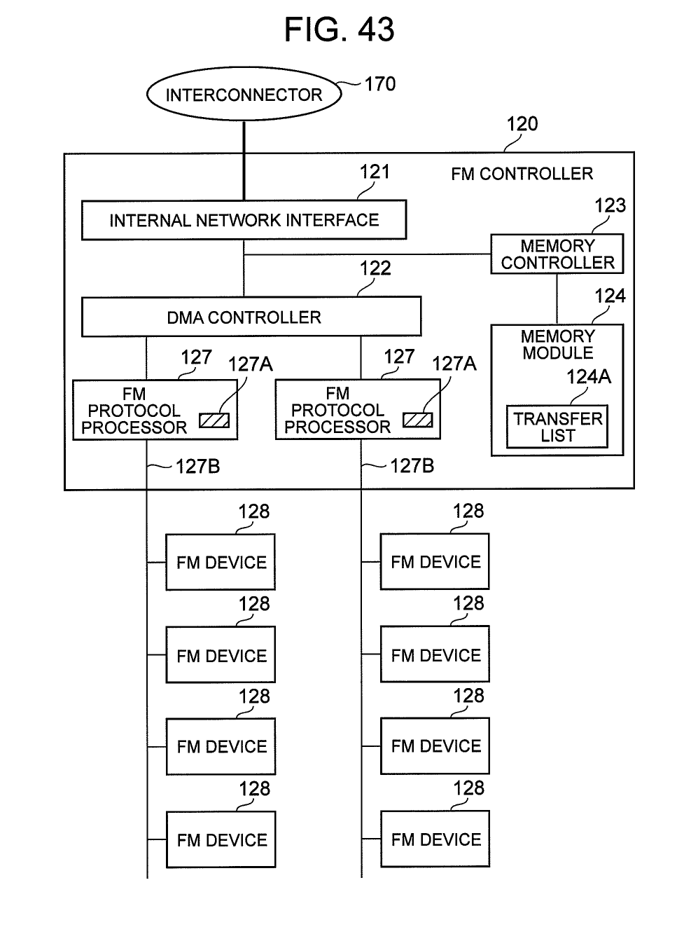

A seventh embodiment will be explained on the basis of FIG. 43. In this embodiment, another variation of the FM controller 120 will be explained. The FM controller 120 of this embodiment connects respective pluralities of flash memory devices 128 to respective FM protocol processors 127 via communication channels 127B. Consequently, in this embodiment, it is possible to use larger numbers of flash memory devices 128.

### Embodiment 8

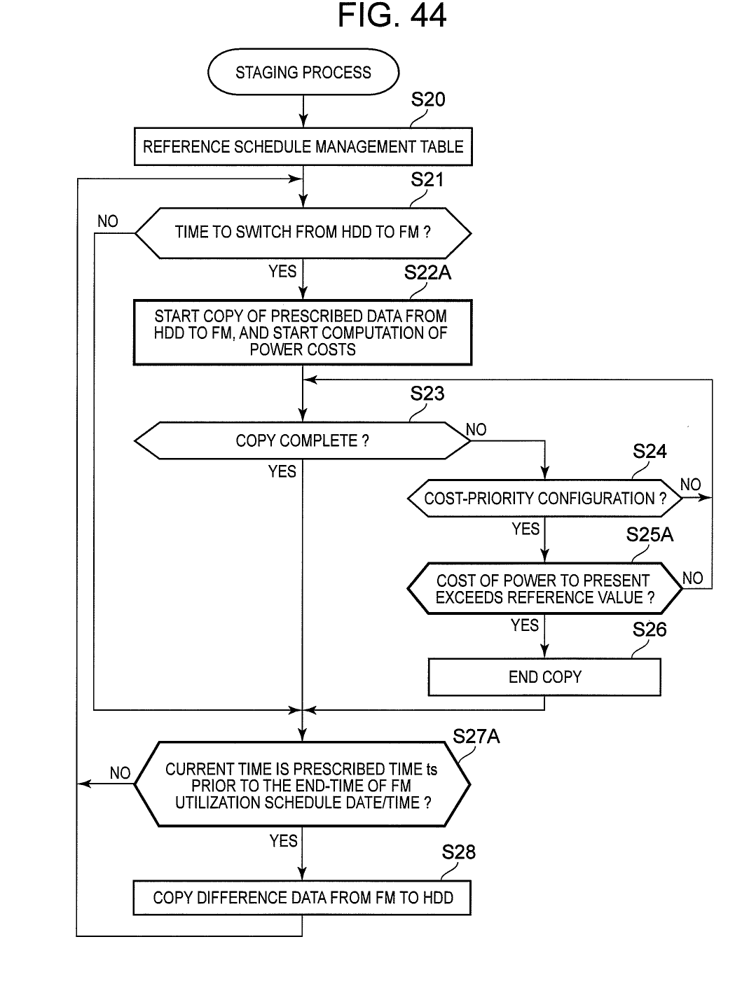

An eighth embodiment will be explained on the basis of FIG. 44. In this embodiment, an example that differs from the first embodiment will be explained as the timing for switching between the use of the flash memory device 120 and the disk drive 210.

FIG. 44 is a flowchart showing a data prior-copy process executed by the storage controller 10 according to this embodiment. The flowchart shown in FIG. 44 comprises steps shared in common with the flowchart shown in FIG. 20. Accordingly, a duplicative explanation will be omitted, and the explanation will focus on the characteristic steps in this embodiment.

When it is determined that the time for switching from the disk drive 210 to the flash memory device 120 has arrived (S21: YES), the storage controller 10 commences copying data from the disk drive 210 to the flash memory device 120, and commences computing the approximate cost of the power consumed by the storage controller 10 (S22A).

When a configuration that places priority on costs has been set (S24: YES), the storage controller 10 determines whether or not the power costs estimated up until this time exceed a pre-configured reference value (S25A). The reference value can be pre-configured by the user. The reference value, for example, can be configured as a monetary amount, which shows the upper limit of user allowable power costs. When the estimated amount of the power costs exceeds the reference value (S25A: YES), the storage controller 10 ends the data copy from the disk drive 210 to the flash memory device 120 (S26).

Next, the storage controller 10 determines whether or not the current time is a prescribed time ts prior to the end-time of flash memory device 120 utilization schedule time recorded in the management table (S27A). For example, when the utilization schedule time is configured at “from 09:00 to 18:00 on weekdays”, and “one hour” is configured as the prescribed time ts, the storage controller 10 determines whether or not the current time is 17:00 (18:00-1 hour=17:00).

When YES is determined in S27A, the storage controller 10 commences a differential-copy from the flash memory device 120 to the disk drive 210 (S28). The prescribed time ts can either be configured manually by the user, or can be automatically configured based on a pre-configured prescribed standpoint. The prescribed standpoint, for example, can include the size of the update amount generated while using the flash memory device 120. That is, the prescribed time ts can be configured by making this prescribed time ts correspond to the amount of difference data copied from the flash memory device 120 to the disk drive 210. For example, the greater the amount of difference data, the longer the prescribed time ts can be made.

Constituting this embodiment like this achieves the same effects as the above-mentioned first embodiment. Furthermore, in this embodiment, when the estimated power cost exceeds the reference value, the data copy from the disk drive 210 to the flash memory device 120 is ended, thereby making it possible to curb the generation of power costs that exceed the user's budget. Therefore, the user can appropriately manage the TCO of the storage controller 10, and enhance usability.

Furthermore, in this embodiment, the start-time of a differential-copy from the flash memory device 120 to the disk drive 210 is associatively configured to the utilization schedule date/time of the flash memory device 120, thereby making it possible to commence a differential-copy in accordance with the time that flash memory device 120 utilization ends. Furthermore, the constitution can also be such that the prescribed time ts is done away with, and a differential-copy from the flash memory device 120 to the disk drive 210 is commenced at the point in time of the arrival of the end-time of the utilization schedule date/time.

Furthermore, the present invention is not limited to the embodiments described hereinabove. A person having ordinary skill in the art can carry out various additions and modifications within the scope of the present invention. For example, the constitution can be such that a plurality of types of flash memory devices, the technological nature and performance of which differ, such as a NAND-type flash memory device and a NOR-type flash memory device, are used together in combination with one another.

What is claimed is:

1. A storage system, which connects a plurality of physically separated sites via a communication network, comprising:
a first site, which is included in said plurality of sites and is provided in a first region, and has a first host computer and a first storage controller, which is connected to this first host computer; and
a second site, which is included in said plurality of sites and is provided in a second region, and has a second host computer and a second storage controller, which is connected to this second host computer,
wherein the first storage controller and second storage controller respectively comprise a first storage device for which power consumption is relatively low; a second storage device for which power consumption is relatively high; and a controller for respectively controlling a first data migration for migrating prescribed data between said first storage device and said second storage device, and a second data migration for migrating said prescribed data between said respective sites,
the storage system is provided with a schedule manager for managing schedule information which is used for migrating said prescribed data in accordance with power costs, and in which a first migration plan for migrating said prescribed data between said first storage device and said second storage device inside the same storage controller, and a second migration plan for migrating said prescribed data between said first storage controller and said second storage controller are respectively configured, and
said controller of said first storage controller and said controller of said second storage controller migrate said prescribed data in accordance with said schedule information, which is managed by said respective schedule managers.

2. The storage system according to claim 1, wherein the cost of power in said first region and the cost of power in said second region differ.

3. The storage system according to claim 1 or claim 2, wherein said schedule information is configured in either said first site or said second site, whichever site has a higher cost of power, so as to minimize the rate of operation of said second storage device in the time zone, when said cost of power is relatively high.

4. The storage system according to claim 1 or claim 2, wherein said schedule information is configured in either said first site or said second site, whichever site has a lower cost of power, so as to make the rate of operation of said second storage device in the time zone, when said cost of power is relatively low, higher than the rate of operation in the time zone, when the cost of power is relatively high.

5. The storage system according to any of claims 1 through 4, wherein said first migration plan of said schedule information is configured so as to dispose said prescribed data in said first storage device in the time zone, when said cost of power is relatively high, and to dispose said prescribed data in said second storage device in the time zone, when said cost of power is relatively low.

6. The storage system according to any of claims 1 through 5, wherein said second migration plan of said schedule information is configured such that said prescribed data is disposed in either said first storage controller or said second storage controller, whichever has said lower cost of power.

7. The storage system according to any of claims 1 through 6, wherein said first controller processes an access request from said first host using said first storage device inside said first storage controller, and said second controller processes an access request from said second host using said second storage device inside said second storage controller.

8. The storage system according to any of claims 1 through 7, wherein said schedule manager is provided in both said first site and said second site, and said schedule manager inside said first site shares said schedule information with said schedule manager inside said second site.

9. The storage system according to any of claims 1 through 8, wherein logical volumes are respectively provided in said first storage device and said second storage device, and
said prescribed data migration between said first storage device and said second storage device is carried out using said respective logical volumes.

10. The storage system according to any of claims 1 through 9, wherein a third migration plan for shifting job processing between said first host computer and said second host computer is also configured in said schedule information in accordance with said cost of power.

11. The storage system according to claim 10, wherein said third migration plan is configured so as to be implemented in conjunction with said second migration plan.

12. The storage system according to any of claims 1 through 10, wherein the storage controller inside the site, which constitutes the migration-source of said respective sites, upon implementing said second migration plan, selects from among said other respective sites a migration-destination site, which coincides with a pre-configured prescribed condition, and executes said second migration plan to the storage controller inside this migration-destination site.

13. The storage system according to claim 12, wherein said prescribed condition comprises at least one condition from among a communication channel for copying data between said migration-source site and said migration-destination site having been configured; the response time, when said prescribed data is migrated to said storage controller inside said migration-destination site, exceeding a pre-configured minimum response time; and said storage controller inside said migration-destination site comprising the storage capacity for storing said prescribed data.

14. The storage system according to any of claims 1 through 13, further comprising an access status manager for detecting and managing the state in which either said first host computer or said second host computer accesses said prescribed data, and said schedule manager uses said access status manager to create said schedule information.

15. The storage system according to any of claims 1 through 14, wherein said respective controllers estimate the life of said first storage device based on the utilization status of said first storage device, and when the estimated life reaches a prescribed threshold, change said prescribed data storage destination to either said second storage device or another first storage device.

16. The storage system according to any of claims 1 through 14, wherein said respective controllers estimate the life of said first storage device based on the utilization status of said first storage device, and when the estimated life reaches a prescribed threshold and the ratio of read requests for said first storage device is less than a pre-configured determination threshold, change said prescribed data storage destination to either said second storage device or another first storage device.

17. The storage system according to any of claims 1 through 16, wherein said first storage device is a flash memory device, and said second storage device is a hard disk device.

18. A data migration method for migrating data between a plurality of physically separated sites for said storage system which comprises: a first site, which is included in said plurality of sites and is provided in a first region, and has a first host computer, and a first storage controller, which is connected to this first host computer; and a second site, which is included in said plurality of sites and is provided in a second region, and has a second host computer, and a second storage controller, which is connected to this second host computer,
said first storage controller and said second storage controller respectively comprising a first storage device for which power consumption is relatively low; a second storage device for which power consumption is relatively high; and a controller for respectively controlling a first data migration for migrating prescribed data between said first storage device and said second storage device, and a second data migration for migrating said prescribed data between said respective sites,
said data migration method comprising the steps of:
migrating said prescribed data between said first storage device and said second storage device inside the same storage controller in accordance with the cost of power; and
migrating said prescribed data between said first storage controller and said second storage controller in accordance with the cost of power.
